(19) United States
(12) Patent Application Publication
(10) Pub. No.: US 2026/0238073 A1
(43) Pub. Date: Aug. 13, 2026

(54) GENERATOR COMPRISING A REMOVABLE REAR PANEL

(71) Applicant: Discovery Energy, LLC, Kohler, WI (US)

(72) Inventors: Raymond KULOW, Sheboygan Falls, WI (US); Asher EVRAETS, Howards Grove, WI (US); Amol HADOLE, Pune (IN); Nitin DABADE, Pune (IN)

(73) Assignee: Discovery Energy, LLC, Kohler, WI (US)

(21) Appl. No.: 19/531,852

(22) Filed: Feb. 6, 2026

Related U.S. Application Data
(60) Provisional application No. 63/755,862, filed on Feb. 7, 2025.

(51) Int. Cl. H02K 5/22; F02B 63/04; H02K 7/18

(52) U.S. Cl. CPC H02K 5/22; F02B 63/042; F02B 63/044; H02K 7/1815; F02B 2063/045

(57) ABSTRACT

A generator comprising a frame defining an interior space, a removable rear panel, and a lid movable between an open position and a closed position is disclosed. When the lid is in its closed position, the lid extends over the interior space. When the lid is in its open position, the lid is positioned entirely above the interior space and the rear panel such that the rear panel can be detached from the frame so that a technician can access at least a portion of the interior space without having to detach the lid.

### CROSS-REFERENCE TO RELATED APPLICATION

This application claims priority under 35 U.S.C. §119(e) to U.S. Provisional Patent Application No. 63/755,862, entitled NEXT GEN PATENTABLE FEATURES EXPLORATION, filed on February 7, 2025, the entire disclosure of which is incorporated by reference herein.

### BACKGROUND

A generator set, or genset, is often used to supply electrical power to a building, such as a house, for example. In various instances, a genset comprises a motor, an alternator driven by the motor, and an enclosure. When the genset is installed, the enclosure may have to be disassembled to mount the genset in position and couple the genset to an electrical load. Disclosed herein are improvements over the foregoing.

### BRIEF DESCRIPTION OF THE DRAWINGS

Exemplary embodiments are described herein with reference to the following drawings.

FIG. 1 is a perspective view of a generator comprising an enclosure illustrated in a closed configuration;

FIG. 2 is a side elevational view of the generator of FIG. 1 in the closed configuration of FIG. 1;

FIG. 3 is a perspective view of the enclosure of FIG. 1 illustrated in an open configuration;

FIG. 3A is a detail view of a breaker cover of the enclosure of FIG. 3;

FIG. 4 is a side elevational view of the enclosure of FIG. 1 illustrated in the open configuration of FIG. 3;

FIG. 5 is a rear perspective view of the enclosure of FIG. 1 illustrated in the open configuration of FIG. 3;

FIG. 6 is an exploded perspective view of the enclosure of FIG. 1;

FIG. 6A is a detail view of an attachment hook of a front panel of the enclosure of FIG. 1;

FIG. 6B is a detail view of a mounting peg of a bottom panel of the enclosure of FIG. 1;

FIG. 6C is a detail view of a mounting hole of a rear panel of the enclosure of FIG. 1 configured to receive a mounting peg of the bottom panel of FIG. 6B;

FIG. 7 is an exploded side elevational view of the enclosure of FIG. 1;

FIG. 8 is an exploded perspective view of the enclosure of FIG. 1;

FIG. 8A is a detail view of the bottom panel of FIG. 6B;

FIG. 9 is an exploded rear perspective view of the enclosure of FIG. 1;

FIG. 9A is a partial perspective view of the attachment hook of FIG. 6A;

FIG. 10 illustrates the enclosure of FIG. 1 with the breaker cover of FIG. 3A and a lateral side panel of the enclosure detached from the enclosure;

FIG. 10A is a detail view of the breaker cover of FIG. 3A detached from the enclosure of FIG. 1;

FIG. 11 is a rear perspective view also showing the detachment of the breaker cover of FIG. 3A and the lateral side panel of FIG. 10 from the enclosure of FIG. 1;

FIG. 12 is a side elevational view of the enclosure of FIG. 1;

FIG. 13 is a cross-sectional view of the enclosure of FIG. 1 taken along line 13-13 in FIG. 12;

FIG. 13A is a detail view of the cross-sectional view of FIG. 13;

FIG. 14 is a cross-sectional view of the enclosure of FIG. 1 taken along line 14-14 in FIG. 12;

FIG. 14A is a detail view of the cross-sectional view of FIG. 14;

FIG. 15 is a view of an engine and alternator of the generator of FIG. 1;

FIG. 16 is a perspective view of a sound attenuator for use with the generator of FIG. 1;

FIG. 17 is a front elevational view of the sound attenuator of FIG. 16;

FIG. 18 is a side elevational view of the sound attenuator of FIG. 16;

FIG. 19 is a cross-sectional view of the sound attenuator of FIG. 16 taken along line 19-19 in FIG. 17;

FIG. 20 is a cross-sectional view of the sound attenuator of FIG. 16 taken along line 20-20 in FIG. 17;

FIG. 20A is a detail view taken from FIG. 20;

FIG. 21 is a rear elevational view of the sound attenuator of FIG. 16;

FIG. 22 is a top view of the sound attenuator of FIG. 16;

FIG. 23 is an exploded view of the sound attenuator of FIG. 16;

FIG. 24 is a perspective view of a sound attenuator positionable in an air flow within the generator of FIG. 1; and

FIG. 25 is an exploded view of the sound attenuator of FIG. 24.

### DETAILED DESCRIPTION

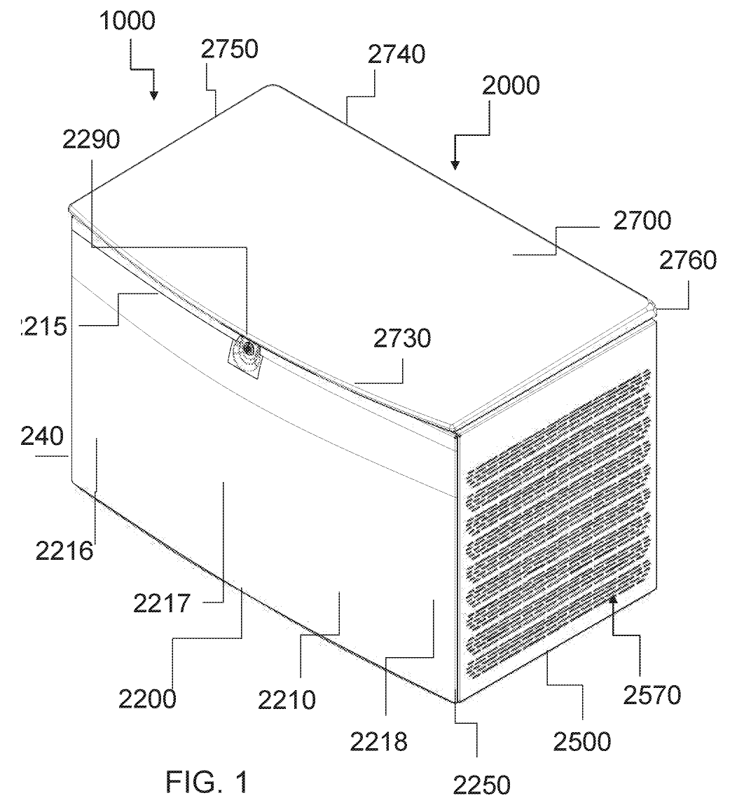

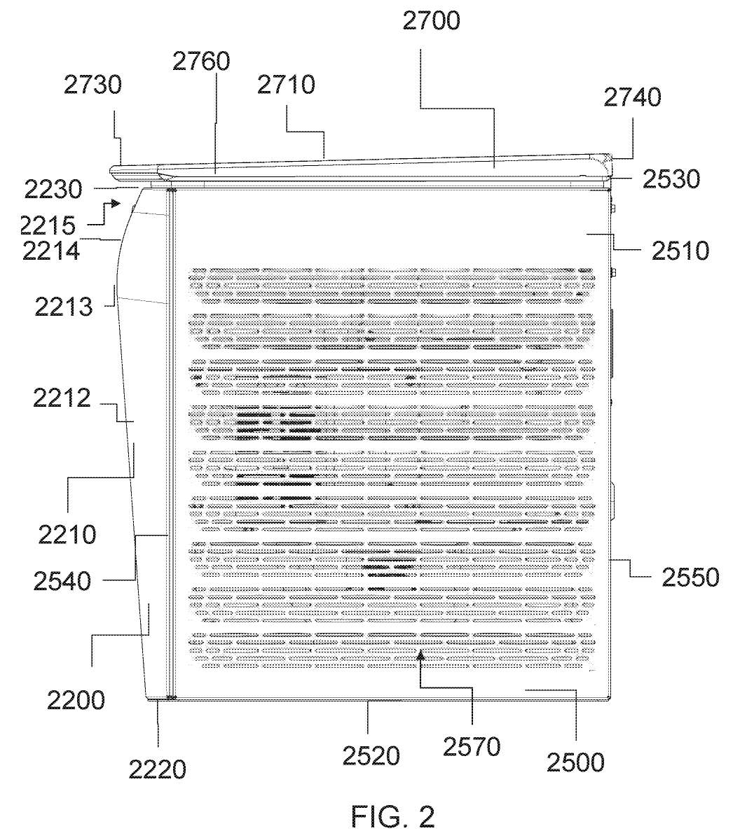

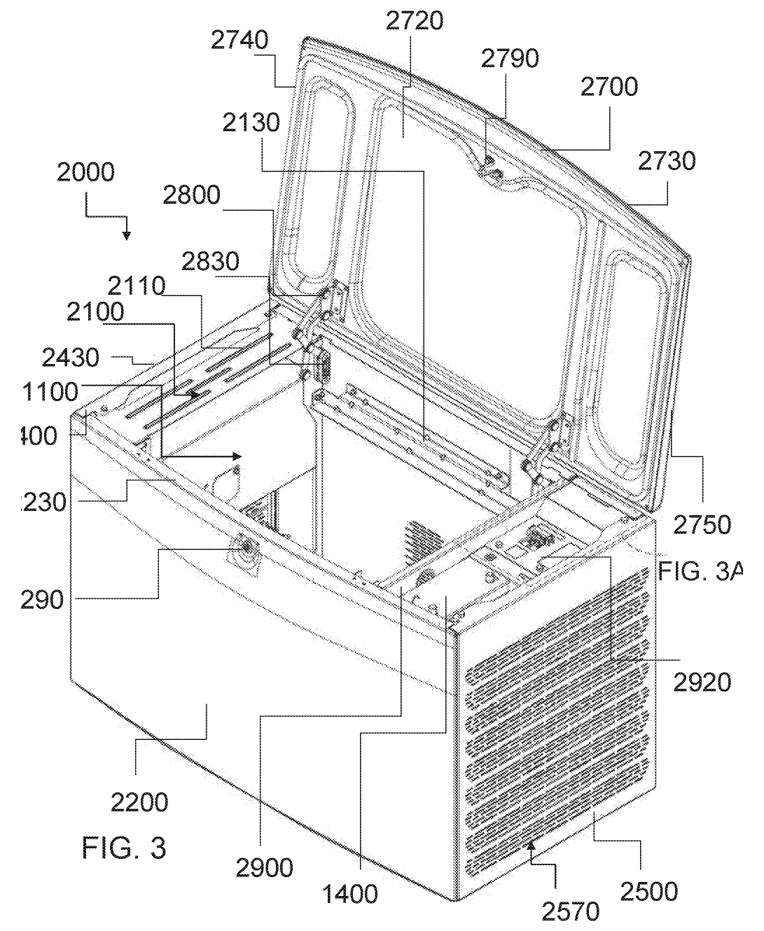

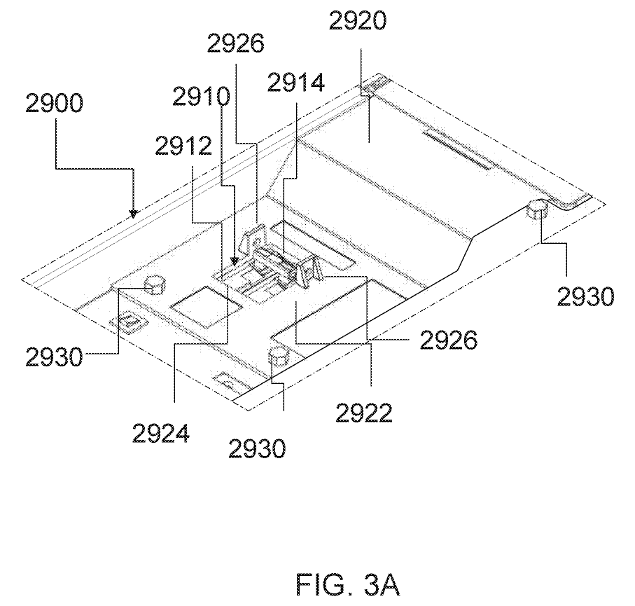

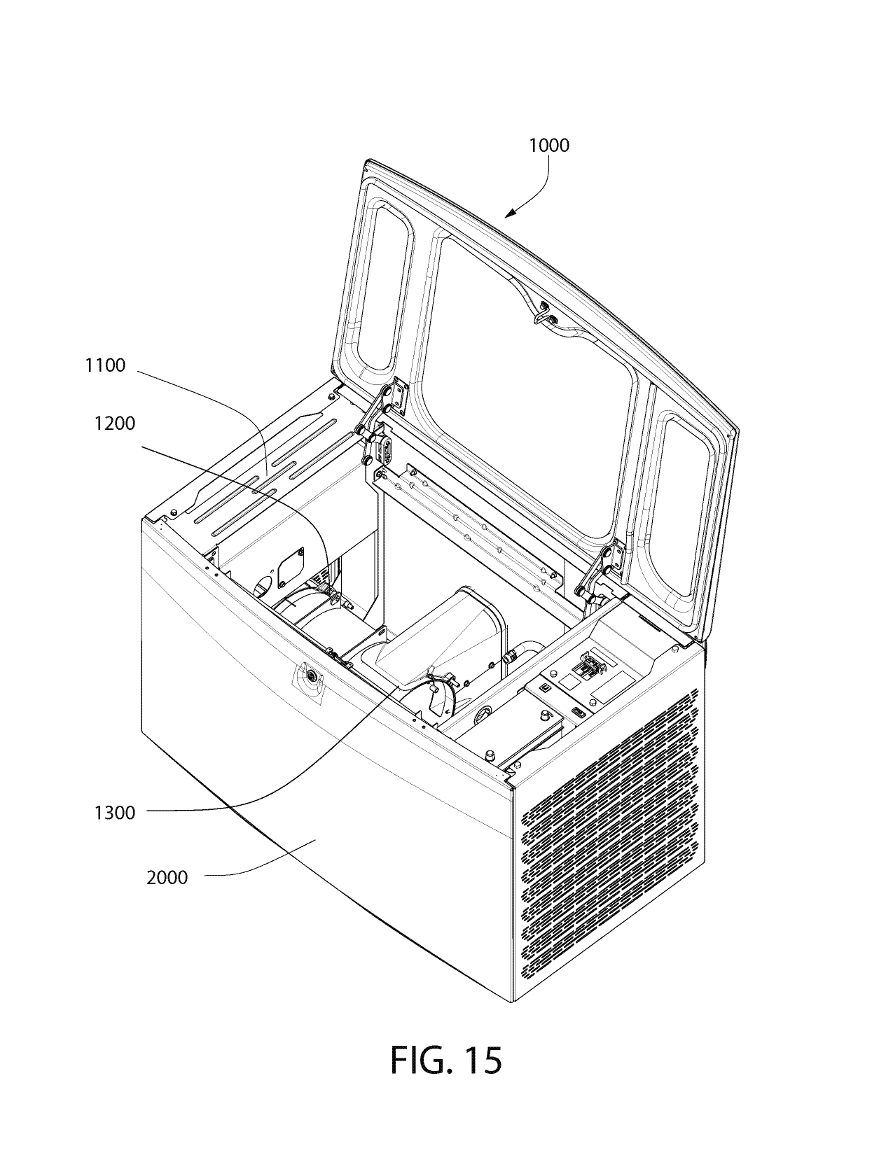

A generator 1000 is illustrated in FIGS. 1 and 2. The generator 1000 comprises an enclosure 2000 that defines an interior 1100. Referring to FIG. 15, the generator 1000 further comprises a motor 1200 and an alternator 1300 that is driven by the motor 1200 that are positioned within the interior 1100 of the enclosure 2000. Referring to FIGS. 1-3, 6, and 8, the enclosure 2000 is rectangular, or at least substantially rectangular; however, the enclosure 2000 can comprise any suitable shape. The enclosure 2000 comprises a frame 2100, a front panel 2200, a rear panel 2300 positioned opposite the front panel 2200, a first lateral side panel 2400 extending between the front panel 2200 and the rear panel 2300, a second lateral side panel 2500 positioned opposite the first lateral side panel, a bottom panel 2600, and a lid, or cover, 2700 that is movable between a closed position, as illustrated in FIG. 1 and 2, and an open position, as illustrated in FIG. 3. As described in greater detail below, the rear panel 2300 comprises a primary rear panel and the enclosure 2000 further comprises a secondary rear panel 2300’ adjacent the rear panel 2300.

Referring primarily to FIGS. 3, 5, 6, 6A, and 8, the frame 2100 is rectangular, or at least substantially rectangular; however, the frame 2100 can comprise any suitable shape. The frame 2100 comprises a first end 2110 and a second end 2120 positioned opposite the first end 2110 that are fastened to the bottom panel 2600. The frame 2100 further comprises a front rail 2130 and a rear rail 2140 extending between the first end 2110 and the second end 2120. The front rail 2130 and the rear rail 2140 are fastened to the first end 2110 and the second end 2120 by one or more fasteners such that the rails 2130 and 2140 form a rigid structure with the first and second ends 2110 and 2120 and can support the weight of the front panel 2200, the rear panel 2300, the first side panel 2400, and the second side panel 2500 attached thereto, among other things.

Referring primarily to FIGS. 1 and 2, the front panel 2200 comprises a front portion 2210, a bottom 2220, a top 2230 opposite the bottom 2220, a first side edge 2240 extending between the bottom 2220 and the top 2230, and a second side edge 2250 extending between the bottom 2220 and the top 2230. The front portion 2210 has a compound curvature including a first curvature extending between the bottom 2220 and the top 2230 and a lateral curvature extending between the first side edge 2240 and the second side edge 2250. Referring to FIG. 2, the first curvature includes an inflection peak 2213, an inwardly directed slope 2212 extending between the inflection peak 2213 and the bottom 2220, and an inwardly directed slope 2214 extending between the inflection peak 2213 and the top 2230. Referring to FIG. 1, the lateral curvature includes an inflection peak 2217, an inwardly directed slope 2216 extending between the inflection peak 2217 and the first side edge 2240, and an inwardly directed slope 2218 extending between the inflection peak 2217 and the second side edge 2250.

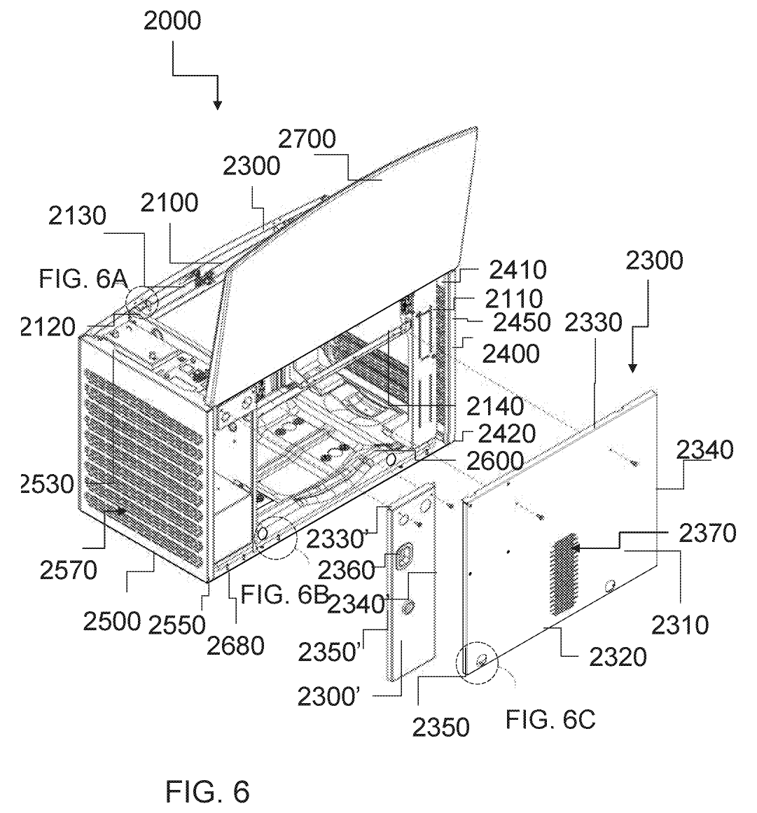

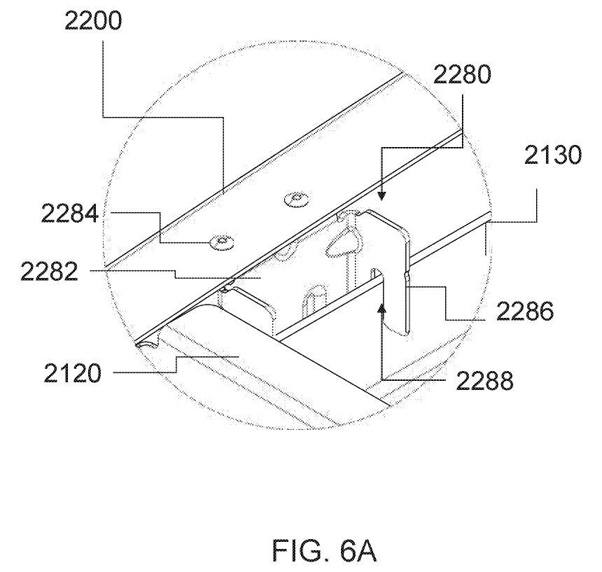

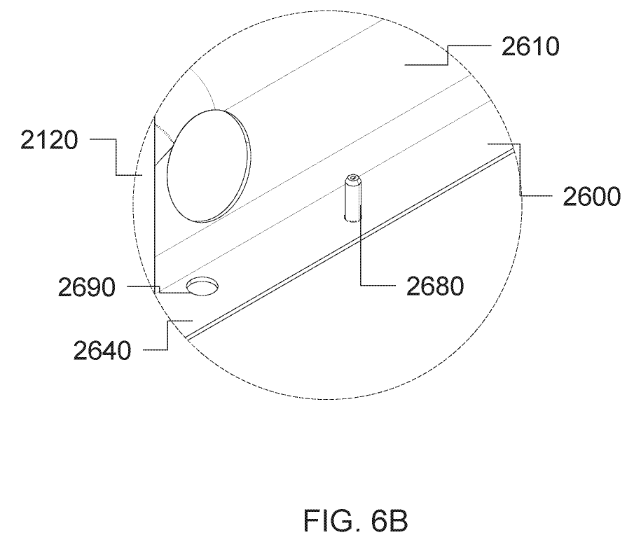

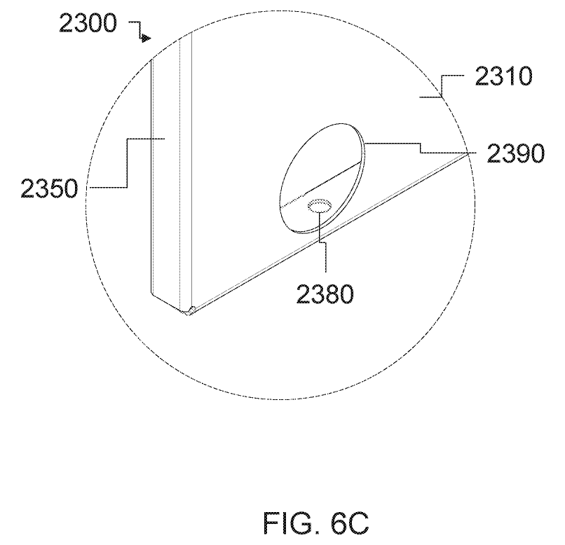

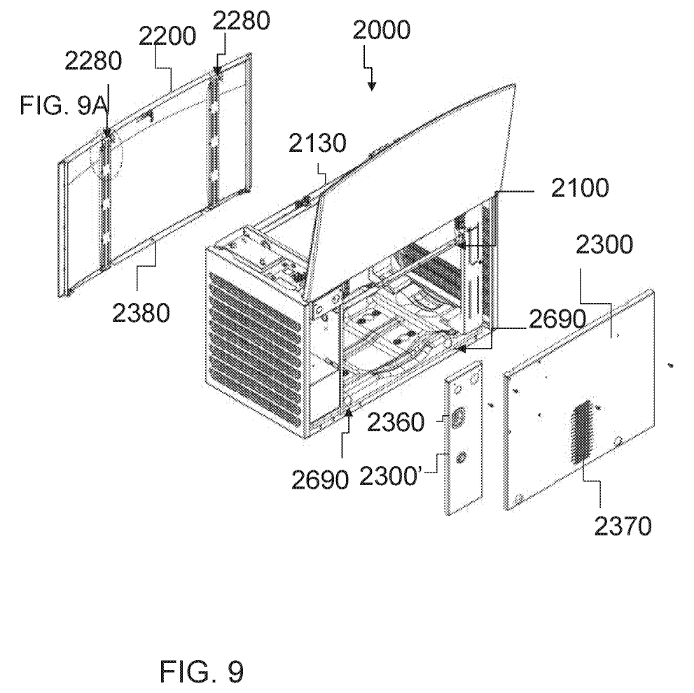

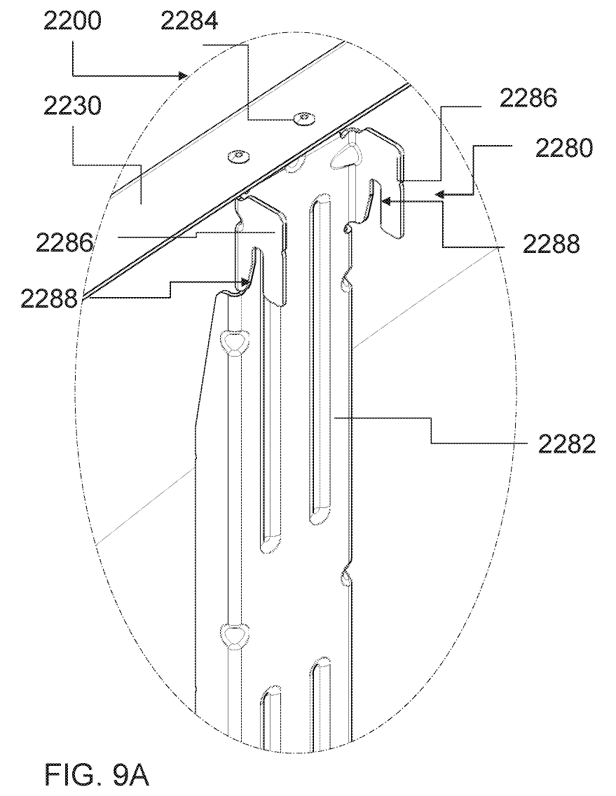

Further to the above, referring to FIGS. 6, 6A, 9, and 9A, the front panel 2200 further comprises hooks 2280 mounted to the backside thereof which are configured to mount the front panel 2200 to the front rail 2130 of the frame 2100. Each hook 2280 comprises a frame 2282 fastened to the top 2230 of the front panel 2200 via fasteners 2284, such as screws, for example. Each hook 2280 further comprises hook arms 2286 integrally formed with the frame 2282 which define slots 2288 therein. Each slot 2288 comprises an open end configured to receive the front rail 2130 therein and a closed end opposite the open end. In various instances, the closed ends of the slots 2288 can be in contact with the front rail 2130 and support at least a portion of the weight of the front panel 2200. In other instances, the closed ends of the slots 2288 may not be in contact with the front rail 2130 and, in such instances, the weight of the front panel 2200 can be supported by the bottom panel 2600. Moreover, as a result of this arrangement, the front panel 2200 can be easily lifted away from the frame 2100 of the enclosure 2000 when installing and/or servicing the generator 1000, for example. Although the front panel 2200 has two hooks 2280, the front panel 2200 can have any suitable number of hooks.

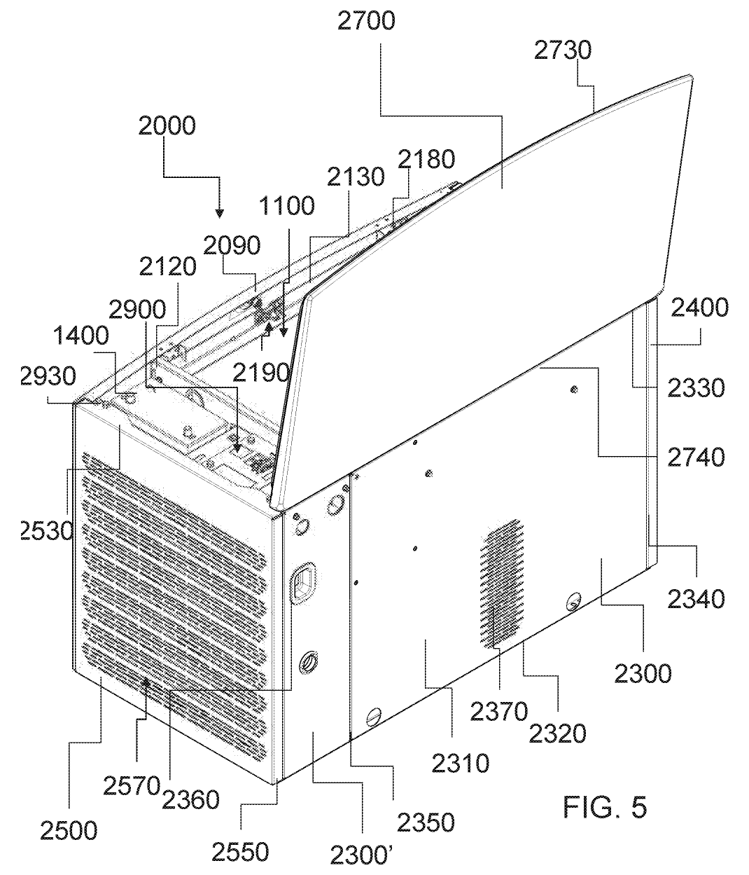

Referring primarily to FIGS. 5, 6, 6B, 6C, 7, and 8, the rear panel 2300 comprises a planar, or an at least substantially planar, body 2310, a bottom 2320, a top 2330 opposite the bottom 2320, a first side 2340, and a second side 2350 opposite the first side 2340. Referring primarily to FIGS. 6B and 6C, the bottom panel 2600 includes pegs 2680 extending upwardly therefrom and the bottom 2320 of the rear panel 2300 comprises apertures 2380 defined therein that are configured to receive the pegs 2680 when the rear panel 2300 is assembled to the frame 2100. In various instances, the apertures 2380 are configured to closely receive the pegs 2680 therein such that the apertures 2380 can align the rear panel 2300 relative to the frame 2100. Once the rear panel 2300 is aligned relative to the frame 2100, the rear panel 2300 can be fastened to the frame 2100 using one or more fasteners, which can comprise screws, for example. Referring primarily to FIG. 6, the secondary rear panel 2300’ is mounted to the frame 2100 and the bottom panel 2600 in a similar manner to that of the rear panel 2300. The secondary rear panel 2300’ comprises a top 2330’ that is aligned with the top 2330 of the rear panel 2300 when the secondary rear panel 2300’ is attached to the frame 2100. The secondary rear panel 2300’ further comprises a first side edge 2340’ adjacent the rear panel 2300 and a second side edge 2350’ adjacent the second side panel 2500.

Further to the above, referring primarily to FIG. 6, electrical wires extend through one or more access ports defined in the secondary rear panel 2300’ which can make the secondary rear panel 2300’ difficult to remove. Moreover, a shutdown switch can be attached to the rear panel 2300’ through a port 2360 which can, similar to the above, make the secondary rear panel 2300’ difficult to remove. The arrangement of the rear panel 2300 and the secondary rear panel 2300’ allows the rear panel 2300 to be removed to access the interior 1100 of the enclosure 2000 without having to remove the secondary rear panel 2300’.

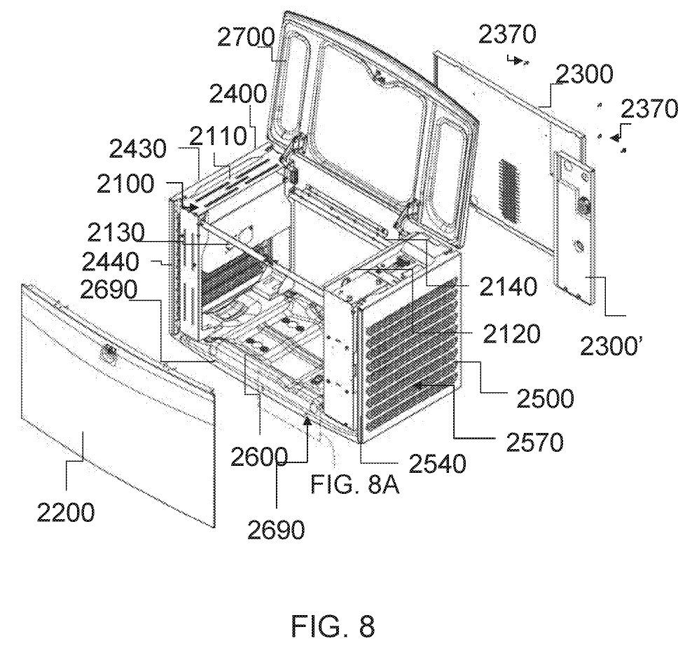

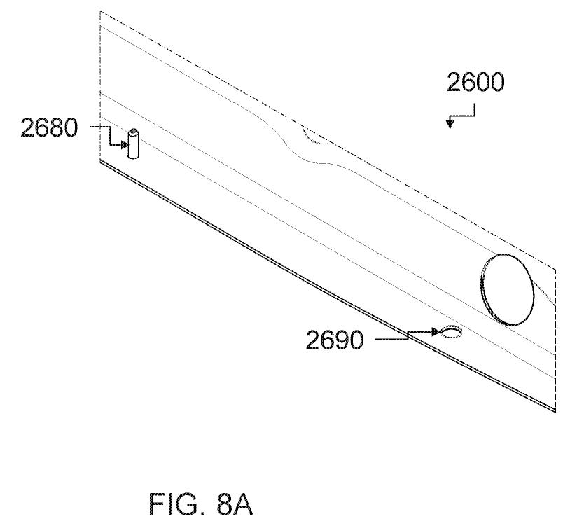

Further to the above, referring primarily to FIGS. 8 and 8A, the bottom panel 2600 comprises a peg 2680 extending upwardly therefrom along a front edge thereof which is configured to be received in an aperture 2380 defined in the bottom 2220 of the front panel 2200. That said, other embodiments are envisioned in which the bottom panel 2600 comprises two or more pegs 2680 extending upwardly therefrom which are each configured to be received in a corresponding aperture 2380 defined in the bottom 2220 of the front panel 2200. When the front panel 2200 is assembled to the frame 2100, the front panel 2200 can be lowered relative to the frame 2100 such that the peg 2680 enters into the aperture 2380 and the hooks 2280 engage the frame 2100 as described above.

In various instances, the generator 1000 is placed on a concrete pad, for example, and then attached to the concrete pad via one or more bolts, for example. Referring primarily to FIGS. 8, 8A, and 9, the bottom panel 2600 comprises four mounting apertures 2690 defined therein that are configured to receive the mounting bolts. More specifically, the rear edge of the bottom panel 2600 comprises two mounting apertures 2690 defined therein and the front edge of the bottom panel 2600 comprises two mounting apertures 2690 defined therein. When installing the generator 1000, the rear panel 2300 can be removed to access the rear mounting apertures 2690 and the front panel 2200 can be removed to access the front mounting apertures 2690. In various instances, four mounting bolts – one extending through each mounting aperture 2690 – can be used to mount the generator 1000 to the mounting pad. In such instances, nuts can be threadably engaged with the mounting bolts and then tightened to secure the generator 1000 to the pad. That said, instances are envisioned in which less than all of the mounting apertures 2690 are used. Such instances can include when the generator 1000 is installed in environments in which the wind is not expected to exceed 150 mph. In such instances, two mounting bolts can be sufficient to mount the generator 1000 to the mounting pad. In at least one such instance, the two front mounting apertures 2690 can be used, without using the two rear mounting apertures 2690, which obviates the need to remove the rear panel 2300 of the enclosure 2000 during installation. Such an arrangement can improve the speed and ease in which the generator 1000 is installed, for instance. In other instances, the two rear mounting apertures 2690 can be used in lieu of the two front mounting apertures 2690.

Referring to FIGS. 3, 6, 6C, and 8, the first side panel 2400 comprises an exhaust outlet. In use, exhaust from the motor 1200 flows through apertures defined in the first side panel 2400, which are described in greater detail below in connection with the second side panel 2500. The first side panel 2400 comprises a planar body 2410, a bottom 2420, a top 2430 opposite the bottom 2420, a first lateral side 2440, and a second lateral side 2450 opposite the first lateral side 2440. Similar to the front panel 2200 and the rear panel 2300, the first side panel 2400 can be mounted to the enclosure 2000 via one or more pegs 2680 extending upwardly from the bottom panel 2600. The top 2430 of the first side panel 2400 comprises apertures defined therein which are configured to receive fasteners, such as bolts and/or screws, for example, therethrough to engage the first end 2110 of the frame 2100 and mount the first side panel 2400 to the frame 2100.

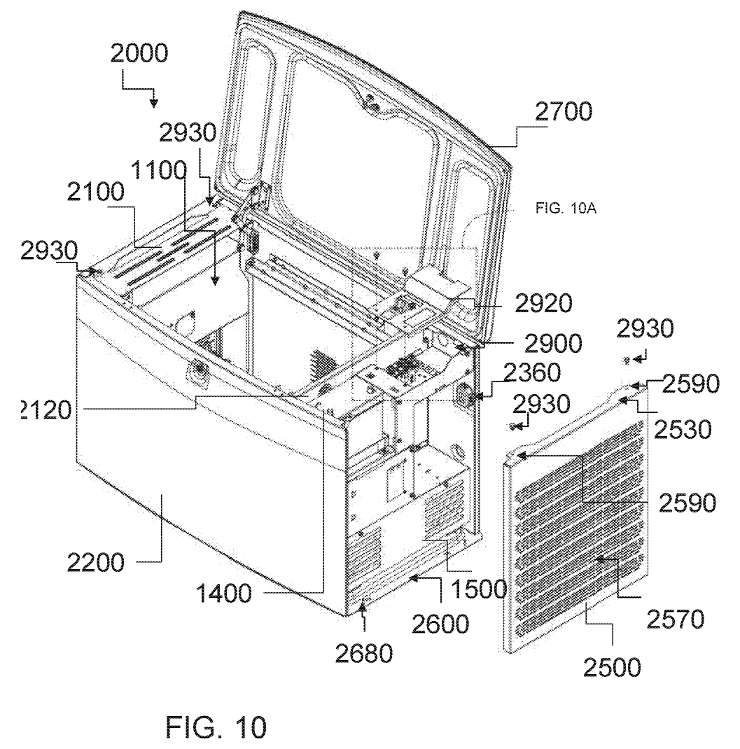

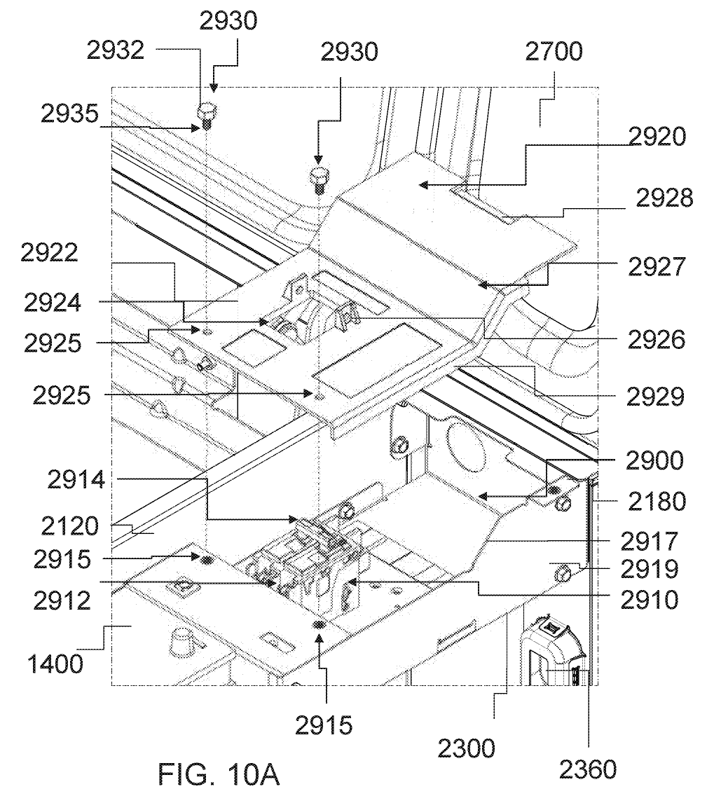

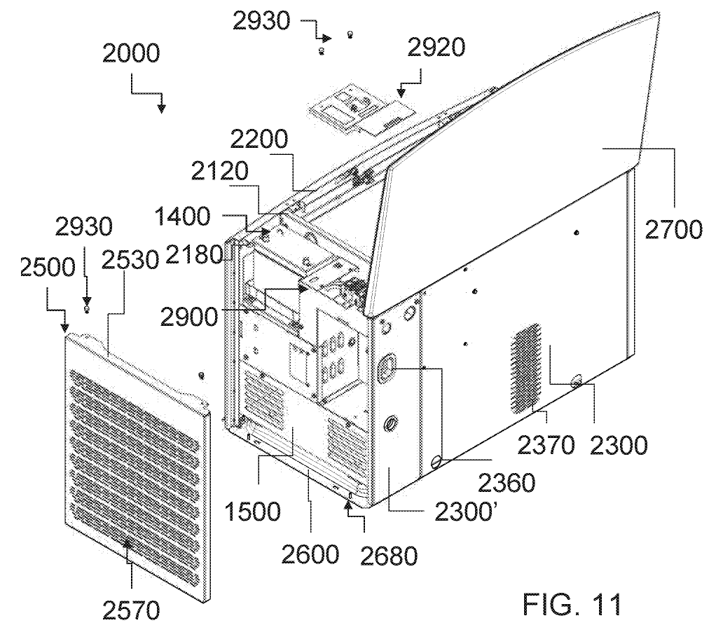

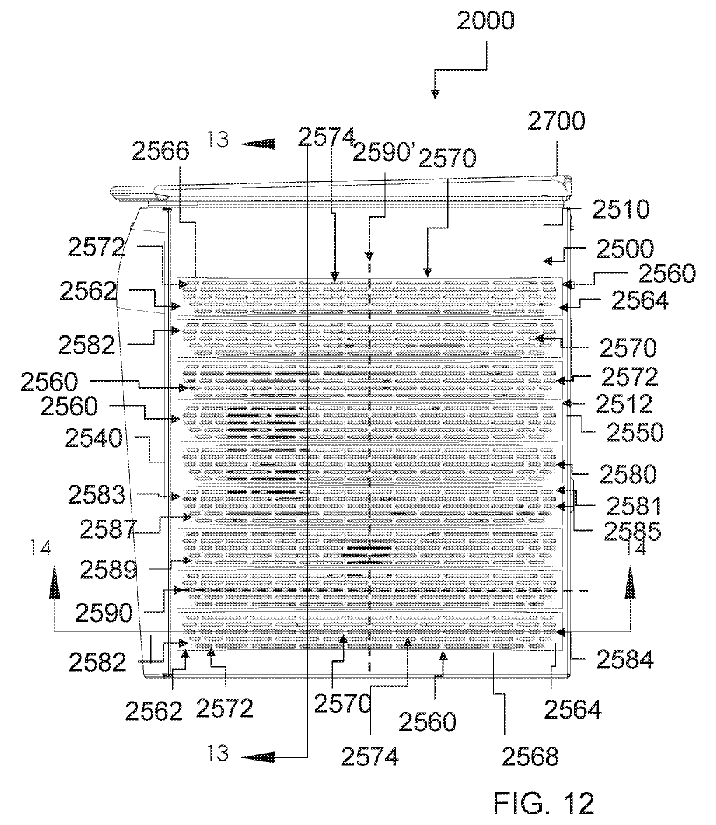

Referring primarily to FIGS. 10 and 11, the second side panel 2500 comprises an air inlet that is aligned with an air manifold 1500 positioned in the enclosure 2000. In use, ambient air flows through apertures 2570 defined in the second side panel 2500, which are best seen in FIG. 12 and described in greater detail below, and then through apertures defined in the air manifold 1500 into the interior 1100 of the enclosure 2000. Such ambient air can supply inlet air to the motor 1200 and/or flow over the engine 1200 to cool the engine 1200 during use. Moreover, the rear panel 2300 comprises inlet apertures 2370 defined therein that are configured to allow ambient air to flow through a flow path extending through and/or around the generator 1300 which cools the generator 1300 during use. The enclosure 2000 further comprises a manifold that mixes the ambient air flowing over the generator 1300 with the exhaust gas of the motor 1200 such that the exhaust gas can be cooled before it exits the enclosure 2000 through the first side panel 2400.

Further to the above, the second side panel 2500 is similar to the first side panel 2400 in many respects. Referring to FIGS. 2, 10, and 11, the second side panel 2500 comprises a planar body 2510, a bottom 2520, a top 2530 opposite the bottom 2520, a first lateral side 2540, and a second lateral side 2550 opposite the first lateral side 2540. Similar to the front panel 2200, the rear panel 2300, and the first side panel 2400, the second side panel 2500 can be mounted to the enclosure 2000 via one or more pegs 2680 extending upwardly from the bottom panel 2600. Referring primarily to FIG. 10, the top 2530 of the second side panel 2500 comprises apertures 2590 defined therein which are configured to receive fasteners 2930 therethrough to engage the second end 2120 and a trough 2919, discussed below, of the frame 2100. Referring to FIGS. 10A and 11, the apertures 2590 defined in the second side panel 2500 are aligned with apertures 2180 defined in the frame 2100 when the second side panel 2500 is aligned with the frame 2100 such that the fasteners 2930 can be inserted through the apertures 2590 in the second side panel 2500 and threadably engaged with the apertures 2180 in the frame 2100. The fasteners 2930 each comprise a head and a threaded shaft extending therefrom wherein the head is sized and configured to be grasped by a technician, for example, and rotated by the technician to tighten and loosed the fasteners 2930. In such instances, tools are not required to detach the second side panel 2500 from the frame 2100; however, tools could be used if desired.

Referring primarily to FIGS. 1-3, the lid 2700 comprises a top surface 2710 and a bottom surface 2720 positioned opposite the top surface 2710. The lid 2700 further comprises a front lip 2730, a backside 2740 positioned opposite the front lip 2730, a first lateral edge 2750 adjacent the first side panel 2400, and a second lateral edge 2760 adjacent the second side panel 2500. The lid 2700 is rotatably mounted to the frame 2100 by hinges 2800 such that the lid 2700 is rotatable between a closed position, illustrated in FIGS. 1 and 2, and a fully-open position, illustrated in FIG. 3. The enclosure 2000 has two hinges 2800; however, the enclosure 2000 may have any suitable number and/or type of hinges. In various instances, the lid 2700 is rotatable 90 degrees or more between its closed position and its fully-open position, for example. In at least one instance, the lid 2700 is moved 100 degrees, for example, between its closed position and its fully-open position. In such a position, the weight of the lid 2700 can tend to hold the lid 2700 in its fully-open position. In other instances, the lid 2700 is moved less than 90 degrees between its closed position and its fully-open position. In such instances, resistance and/or springs within the hinges 2800 can resist the lid 2700 from closing on its own. The enclosure 2000 further comprises a latch assembly configured to releasably hold the lid 2700 in its closed position. Referring primarily to FIG. 3, the latch assembly comprises a latch element 2790 extending downwardly from the bottom surface 2720 of the lid 2700 and a lock 2090 mounted to the frame 2100 that is configured to lockingly engage and hold the latch element 2790 in position. To release the latch element 2790, a lock release 2290 on the front panel 2200 can be depressed which unlocks the lock 2090 and allows the lid 2700 to be lifted into its fully-open position.

Referring again to FIGS. 1-3, the front lip 2730 of the lid 2700 has a contour that matches, or at least substantially matches, the lateral curvature of the front panel 2200. Moreover, referring primarily to FIG. 2, the front lip 2730 protrudes over the slope 2214. In various instances, rain that has fallen onto the lid 2700 when the lid 2700 is in its closed position may drip off of the front lip 2730 onto the ground instead of wicking back under and along the bottom surface 2720 of the lid 2720 into the interior 1100 of the enclosure 2000. Additionally, owing to the inward-extending slope 2214 and the protrusion of the front lip 2730, referring primarily to FIG. 2, a gap 2215 is formed therebetween which provides a convenient location for a technician, for example, to place their hand on the lid 2700 and move the lid 2700 into its open position as described above.

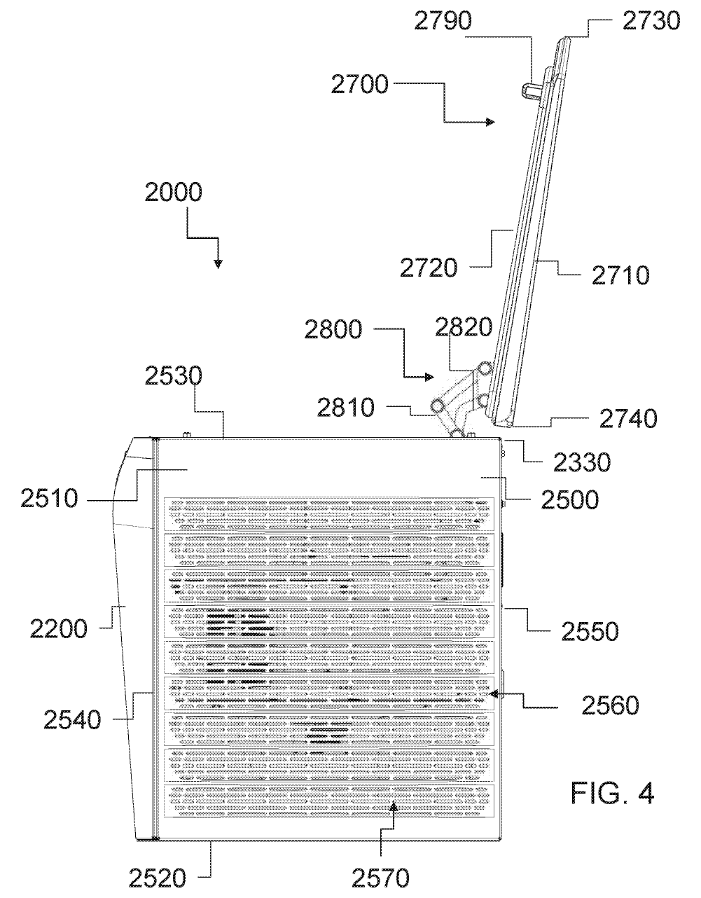

Further to the above, referring primarily to FIGS. 3 and 4, each hinge 2800 comprises a first link, or coupler, 2810 and a second link, or coupler, 2820 that are each pivotably mounted to the lid 2700. More specifically, the first coupler 2810 comprises an end pivotably mounted to the lid 2700 and the second coupler 2820 comprises an end pivotable mounter to the lid 2700. In various instances, each of these pivotable connections comprises a pin inserted through an aperture extending through the couplers 2810, 2820 and an aperture defined in a mounting bracket attached to the bottom side 2720 of the lid 2700. The first coupler 2810 further comprises an opposite end slideably mounted to the first end 2110 of the frame 2100 via a slide rail 2830 mounted to the first end 2110 of the frame 2100. The second coupler 2820 further comprises an opposite end pivotably mounted to the first end 2110 of the frame 2100. Similar to the above, this pivotable connection comprises, in various instances, a pin inserted through an aperture extending through the second coupler 2820 and a mounting aperture defined in the frame 2100. The first coupler 2810 has a compound configuration in which the first coupler 2810 extends in front of and behind the second coupler 2820. As a result of the above-described arrangement of the hinges 2800, the hinges 2800 can hold the lid 2700 in a desirable fully-open position, as described in greater detail below.

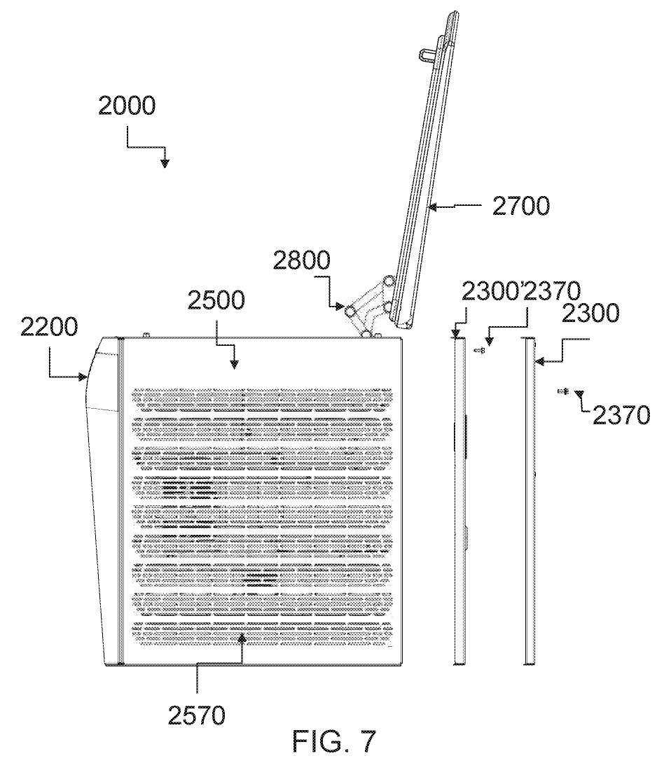

Further to the above, FIGS. 4 and 5 illustrate the lid 2700 in its fully-open position. In this fully-open position, the lid 2700 is positioned entirely above, or vertically above, the top 2230 of the front panel 2200, the top 2330 of the rear panel 2300, the top 2330’ of the secondary rear panel 2300’, the top 2430 of the first side panel 2400, and the top 2530 of the second side panel 2500. Moreover, in this fully-open position, the lid 2700 isn’t positioned directly to the rear of the rear panel 2300, i.e., directly behind the rear panel 2300, and/or the secondary rear panel 2300’. As can be seen in FIG. 4, the lid 2700 has a length extending between its front lip 2730 and its backside 2740 and none of this length is directly behind the rear panel 2300 and/or secondary rear panel 2300’. As a result, the front panel 2200, the rear panel 2300, the first side panel 2400, and the second side panel 2500 can be detached and removed from the enclosure 2000 without having to remove the lid 2700. For instance, referring to FIGS. 6 and 7, the rear panel 2300 (and/or the secondary rear panel 2300’) can be detached from the frame 2100 and/or removed from the enclosure 2000 in order to access the interior 1100 of the enclosure 2000 from the rear. By removing the rear panel 2300 in such a manner, referring to FIG. 6B, the two rear mounting apertures 2690 are exposed which can allow a technician to quickly and easily attach the generator 1000 to a mounting pad. In environments in which the wind can exceed 150 mph, the front panel 2200 and the rear panel 2300 can be detached from the frame 2100 and removed from the enclosure 2000 to expose the two front mounting apertures 2690 and the two rear mounting apertures 2690, respectively, such that a technician can tighten nuts to the mounting bolts, or lags, extending through all four mounting apertures 2690. In various other embodiments, a different wind speed, such as 160 mph, for example, can be used to delineate whether four mounting bolts, or only two mounting bolts, are used to secure the generator 1000 to the pad. In any event, the lid 2700 does not block the removal of the rear panel 2500, and/or any other panel of the enclosure 2000, and the generator 1000 can be installed without having to remove the lid 2700 which can decrease the time needed to install the generator 1000.

Part of installing the generator 1000, further to the above, is, among other things, electrically coupling a load, or load circuit, to the generator 1000. Referring to FIGS. 3, 3A, 4, 5, 10, 10A, and 11, the enclosure 2000 of the generator 1000 comprises an electrical control section 2900 which houses, among other things, a battery 1400, a control unit positioned below the battery 1400, for example, and a circuit breaker 2910. The battery 1400 provides electrical power to the engine 1200 when the engine 1200 is started by the control unit. Once the engine 1200 has started, the engine 1200 drives the alternator 1300 which can, in turn, re-charge the battery 1400. The circuit breaker 2910 is electrically coupled with the alternator 1300 and, in its closed state, the circuit breaker 2910 is configured to supply electrical energy from the alternator 1300 to the load electrically coupled with the circuit breaker 2910. When the circuit breaker 2910 is in its open state, the alternator 1300 and the load are electrically decoupled by the circuit breaker 2910. The electrical control section 2900 also comprises a breaker cover 2920 attached to the frame 2100 which needs to be removed to couple the load with the circuit breaker 2910. That said, the load can be electrically coupled to the generator 1000 by a technician with only having to open the lid 2170 and removing the breaker cover 2920. No other panels need to be removed to electrically couple the generator 1000 with the load. As a result of this arrangement, the generator 1000 can be quickly and easily installed.

Further to the above, referring primarily to FIGS. 3A and 10A, the breaker 2910 comprises a body 2912 mounted to a frame trough 2919 and a handle, or lever, 2914 that is rotatable relative to the body 2912 between an open position and a closed position. The breaker cover 2920 comprises a flat panel 2922 and an aperture, or window, 2924 defined therein. The flat panel 2922 comprises apertures 2925 defined therein that are aligned with apertures 2915 defined in the frame trough 2919 when the breaker cover 2920 is in its seated position, as illustrated in FIG. 3A. The breaker cover 2920 is mounted to the frame trough 2919 via fasteners 2930 which are inserted through the apertures 2925 defined in the breaker cover 2920 and threadably engaged with the frame trough 2919. Each fastener 2930 comprises a head 2932 and a threaded shaft 2935 extending therefrom. The head 2932 is sized and configured to be gripped by a technician, for example, such that the technician can loosen and/or tighten the fasteners 2930 without the use of tools, if desired. The aperture 2924 is sized and configured to receive the lever 2914 therethrough and permit the lever 2914 to be rotated between its open and closed positions. The breaker cover 2920 further comprises guards 2926 extending upwardly from the flat panel 2922 which protect the lever 2914 from being accidentally actuated, for example. Moreover, one or both of the guards 2926 is configured to be engaged by a lock that can prevent the lever 2914 from being sufficiently rotated to switch the breaker 2910 into its closed position. Once the lock is removed, the lever 2914 can be rotated between its open and closed positions. In at least one instance, the guards 2926 comprise apertures defined therein through which a portion of the lock can extend.

Further to the above, the breaker cover 2920 further comprises a lip 2929 extending downwardly from the flat panel 2922 which is configured to assist in aligning the breaker cover 2920 with the frame trough 2919. Moreover, the frame trough 2919 and the breaker cover 2920 comprise co-operating angled surfaces 2917 and 2927, respectively, which also assist in aligning the breaker cover 2920 with the frame trough 2919. The breaker cover 2920 further comprises a tab 2928 which is configured to assist a technician in aligning, seating, and/or removing the breaker panel 2920.

In various instances, the generator 1000 can be installed by removing the front panel 2200 and the breaker cover 2920 without having to remove the rear panels 2300 and 2300’, the first lateral side panel 2400, the second lateral side panel 2500, the bottom panel 2600, and the lid 2700. The front panel 2200 is removed to access the two front mounting apertures 2690 in the bottom panel 2600 so that that the bottom panel 2600 can be fastened to the mounting pad. To perform this mounting step, the rear panels 2300 and 2300’, the side panels 2400 and 2500, and the lid 2700 do not have to be removed. That said, the rear panel 2300 can be optionally removed to access the two rear mounting apertures 2690 to further mount the bottom panel 2600 to the mounting pad in high wind environments, for example. The breaker cover 2920 is removed in order to electrically couple a load circuit with the breaker 2910. This step of electrically coupling the breaker 2910 with the load circuit can be performed without having to remove the front panel 2200, the rear panels 2300 and 2300’, the side panels 2400 and 2500, the bottom panel 2600, and the lid 2700. The above being said, any suitable installation method can be used to install the generator 1000.

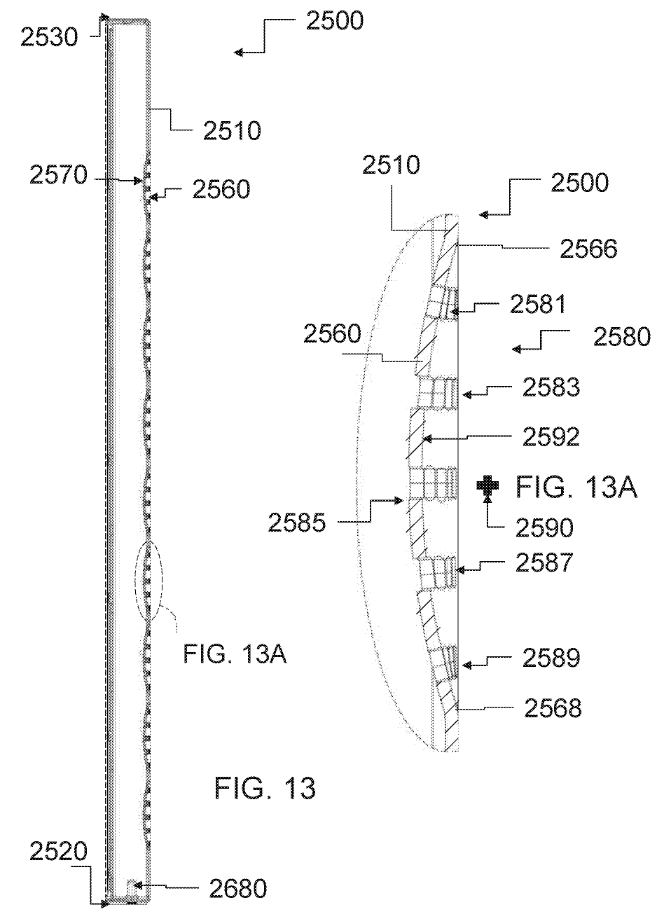

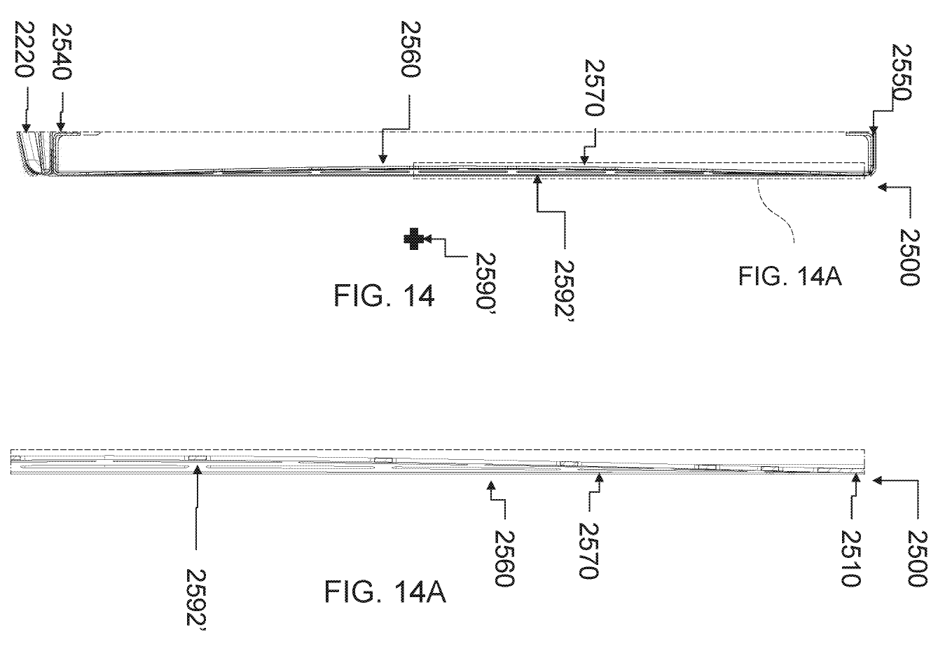

Further to the above, referring to FIGS. 12, 13, 13A, 14, and 14A, the first side panel 2400 and the second side panel 2500 each have an arrangement of depressions and apertures which, respectively, allow air to enter into the enclosure 2000 and exhaust to exit from the enclosure 2000 without undermining the structural integrity of the first and second side panels 2400 and 2500. The first side panel 2400 comprises the same features as the second side panel 2500; however, only the second side panel 2500 is discussed below for the sake of brevity. Further to the above, referring primarily to FIG. 12, the second side panel 2500 comprises a planar body 2510 comprised of sheet metal, for example. The second side panel 2500 further comprises depressions 2560 formed into the planar body 2510. The second side panel 2500 has nine depressions 2560 formed therein; however, the second side panel 2500 can have any suitable number of depressions 2560. Each depression 2560 has a first end 2562 adjacent the first lateral side 2540 of the second side panel 2500 and a second end 2564 adjacent the second lateral side 2550 of the second side panel 2500. Referring primarily to FIGS. 13, 13A, 14, and 14A, each depression 2560 is defined by a compound curvature. The compound curvature is defined by at least two radiuses of curvature, i.e., a first radius of curvature 2592 and a second radius of curvature 2592’. Referring primarily to FIG. 13A, the first radius of curvature 2592 is defined about a first axis 2590 that extends horizontally relative to the second side panel 2500. In a sense, the first radius of curvature 2592 defines a first curvature that is oriented vertically about the horizontal first axis 2590. Referring primarily to FIG. 14A, the second radius of curvature 2592’ is defined about a second axis 2590’ that extends vertically relative to the second side panel 2500. In a sense, the second radius of curvature 2592’ defines a second curvature that is oriented horizontally relative to the second side panel 2500. The first curvature and the second curvature define a curved contour, or gradual gulley, of the depression 2560 that extends between the first end 2562 and the second end 2564 of the depression 2560 and, likewise, between a top edge 2566 and a bottom edge 2568 of the depression 2560. Notably, the first radius of curvature 2592 is smaller than the second radius of curvature 2592’. As a result, the horizontal curve of the depression 2560 is generally more gradual than the vertical curve of the depression 2560. That said, a depression can be defined by any suitable number and/or types of curvatures. In various embodiments, a depression can be defined by one or more polygonal features, for example. In at least one such embodiment, the bottom of a depression can be flat, for example, and the sidewalls of the depression can comprise flat slopes extending between the bottom of the depression and the planar body 2510, for example.

Referring primarily to FIGS. 12 and 13A, the apertures 2570 are defined in rows 2580 in the depressions 2560. Each row 2580 of apertures 2570 in a depression 2560 comprises a first row end 2582 at the first end 2562 of the depression 2560 and a second row end 2584 at the second end 2564 of the depression 2560. Within each row 2580, the apertures 2570 have different sizes. For instance, the first and second row ends 2582 and 2584 of a row 2580 have small apertures 2572 and the center of the row 2580 has large apertures 2574 that are larger than the small apertures 2572. The apertures 2572 and 2574 are elongate laterally, and the small apertures 2572 have a shorter elongate lateral length than the large apertures 2574. That said, the small apertures 2572 and the larger apertures 2574 have the same, or at least substantially the same, transverse, or vertical, widths. In various instances, the elongate lengths of the apertures 2570 within a row 2580 can have a gradation along the length of the row 2580. For instance, the apertures 2570 at the ends 2582, 2584 of a row 2580 can have the shortest elongate lengths and the apertures 2570 in the middle of the row 2580 can have the longest elongate lengths with the apertures 2570 in between the ends 2582, 2584 and the middle of the row 1580 having decreasing elongate lengths as measured from the middle of the row 2580 toward the ends 2582, 2584. The above being said, the apertures 2570 can have any suitable arrangement of elongate lengths and/or sizes. Moreover, the apertures 2570 can have any suitable configuration, such as round and/or polygonal shapes, for example. Additionally, the apertures 2570 can be arranged in any suitable arrangement that does or does not comprise rows. In at least one embodiment, the apertures 2570 can be arranged in a random, or an at least seemingly unorganized, pattern that includes two or more sizes of apertures 2570, for example.

Further to the above, referring primarily to FIG. 12 and 13A, the rows 2580 of apertures 2570 in a depression 2560 are arranged in parallel rows. Within a depression 2560, the rows 2580 comprise a first row 2581, a second row 2583, a third row 2585, a fourth row 2587, and a fifth row 2589. Each of the rows 2581, 2583, 2585, 2587, and 2589 have different lengths; however, other embodiments are envisioned in which some of, or all of, the rows 2581, 2583, 2585, 2587, and 2589 have the same length. In embodiments where at least some of the rows 2581, 2583, 2585, 2587, and 2589 have different lengths, the rows 2581, 2583, 2585, 2587, and 2589 can be arranged in an advantageous pattern. For instance, the rows 2581, 2583, 2585, 2587, and 2589 are arranged such that the ends of the rows co-operatively form echelons, or arrowhead configurations. The echelons formed by the row ends 2582, 2584 point outwardly toward the front panel 2200 and the rear panel 2300 of the enclosure 2000, respectively. In this arrangement, the second row 2583 has a longer length than the first row 2581, the third row 2585 has a longer length than the second row 2583 and the fourth row 2587, and the fourth row 2587 has a longer length than the fifth row 2589. As a result of the above-described arrangement, the rows 2580 have less apertures 2570, and smaller apertures 2570, adjacent the ends 2562 and 2564 of the depressions 2560, i.e., in the shallowest parts of the depressions 2560. Correspondingly, the apertures 2570 positioned in the deepest portions of the depressions 2560 can be larger and/or more numerous than at the ends 2562, 2564 of the depressions 2560. In various instances, as a result, the potential for rain and/or wind to enter into the enclosure 2000 through the apertures 2570 can be reduced. The above being said, any suitable lengths of the rows 2581, 2583, 2585, 2587, and 2589 can be used to form any suitable pattern and/or create any suitable advantage.

Further to the above, the depressions 2560 defined in the planar body 2510 can, in various instances, increase the rigidity of the second side panel 2500 whereas the apertures 2570 can, in various instances, decrease the rigidity of the second side panel 2500. By placing the apertures 2570 in the depressions 2560, the localized weakness created by the apertures 2570 can be offset by, or at least partially offset by, the localized strength created by the depressions 2560. In various instances, the arrangement of the depressions 2560 and the apertures 2570 defined in the depressions 2560 can define louvers. The above being said, the positioning of the apertures 2570 is not limited to the depressions 2560. Other embodiments are envisioned in which at least some of the apertures 2570 are not positioned in a depression 2560. In at least one such embodiment, the advantages provided by the rows 2581, 2583, 2585, 2587, and 2589, and their respective lengths, can still be achieved, or at least substantially achieved, without the depressions 2560, for example. Nonetheless, referring primarily to FIG. 13A, positioning the apertures 2570 in the depressions 2560 does provide additional advantages. In various instances, rain dripping down the planar body 2510 may drip off the second side panel 2500 when the rain reaches the top edge 2566 of a depression 2560 instead of ingressing into the apertures 2570 in the depression 2560. In various instances, a flat 2512 is positioned intermediate adjacent depressions 2560 which can provide a drip point for rain flowing down the second side panel 2500.

The front panel 2200, the rear panel 2300, the first side panel 2400, the second side panel 2500, the bottom panel 2600, and the lid 2700 are comprised of sheet metal, such as stainless steel and/or aluminum, for example, but can be comprised of any suitable material, such as plastic, for example. In various instances, the first and second side panels 2400 and 2500, for example, can be created by one or more stamping processes, for example. In various instances, a piece of sheet metal can be punched to create the apertures 2570 and then stamped to create the depressions 2560. In other instances, the depressions 2560 are created and then the apertures 2570 are stamped into the depressions 2560. Other embodiments are envisioned in which the depressions 2560 and the apertures 2570 are created in a single stamping/punching operation. Moreover, various embodiments are envisioned in which the front panel 2200, the rear panel 2300, the first side panel 2400, the second side panel 2500, the bottom panel 2600, and/or the lid 2700 are formed during a plastic injection molding and/or thermoforming process, for example.

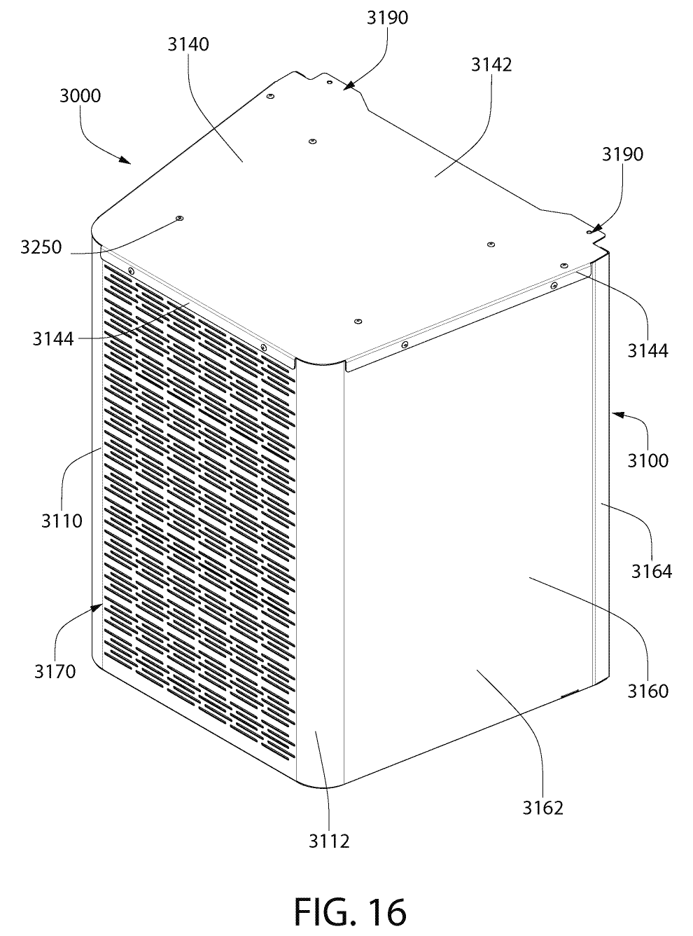

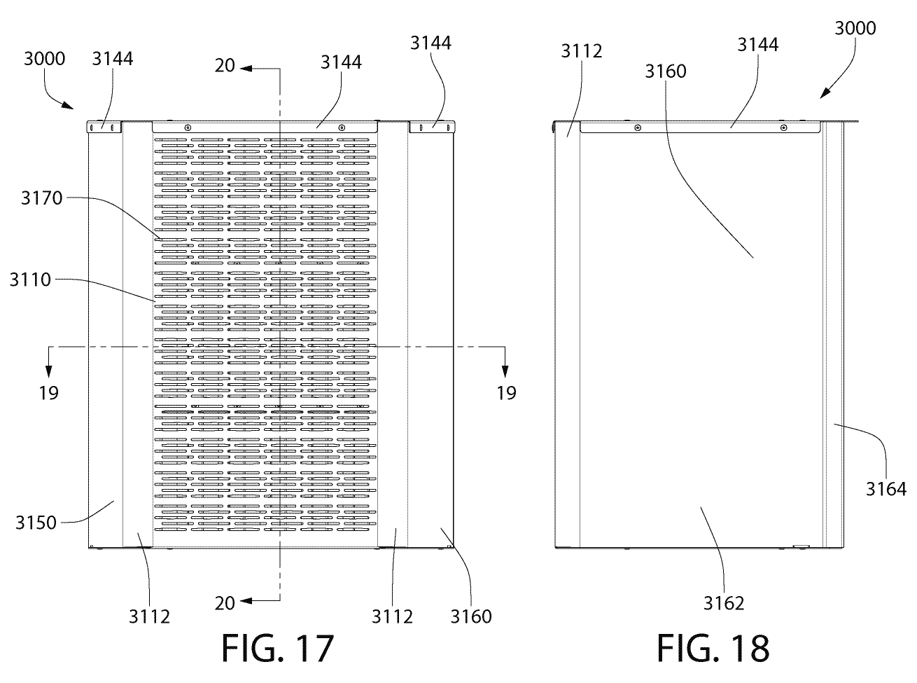

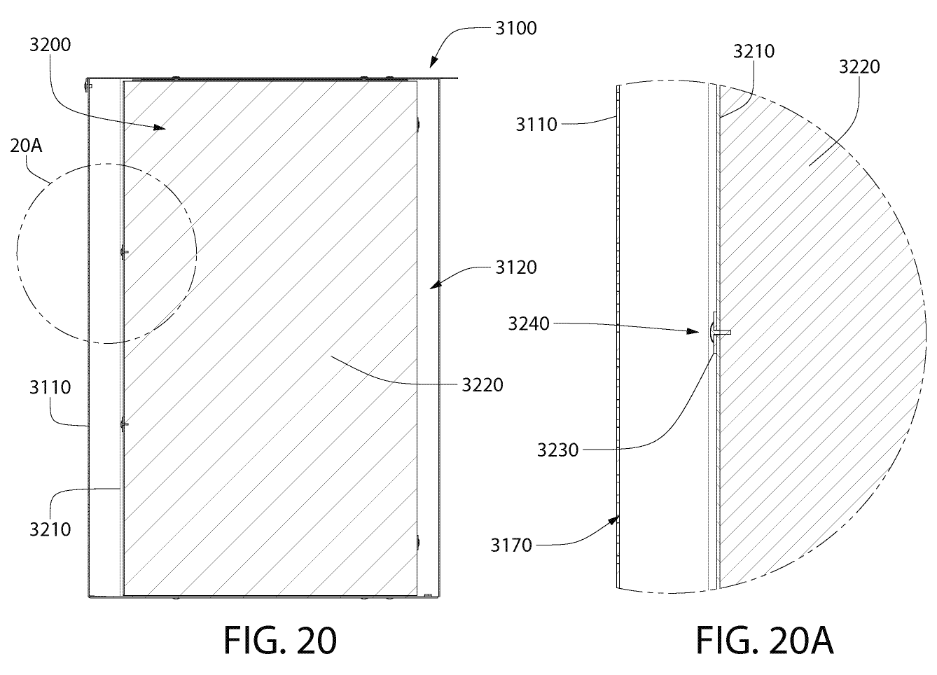

When the engine 1200 of the generator 1000 is operating, further to the above, the engine 1200 and alternator 1300 generate sound energy that is transmitted through the enclosure 2000 into the surrounding environment. In some instances, a lot of sound energy is transmitted through the apertures 2570 defined in the first side panel 2400 and the second side panel 2500, for example. In many instances, it is desirable to attenuate, or reduce, the sound energy emitted from the enclosure 2000. A sound attenuator 3000 for use with the generator 1000 is illustrated in FIGS. 16-23 and can be used to replace the first side panel 2400 or the second side panel 2500. For instance, the first side panel 2400 can be detached and removed from the enclosure 2000 and then replaced with the sound attenuator 3000. Similarly, the second side panel 2500 can be detached and removed from the enclosure 2000 and then replaced with the sound attenuator 3000. It is envisioned that the sound attenuator 3000 can be sold as an individual item or as a kit. In various instances, a kit can comprise two sound attenuators 3000, for example, such that both the first side panel 2400 and the second side panel 2500 of an enclosure can be replaced. Once one or both of the sound attenuators 3000 are attached to the enclosure 2000, the sound energy emitted from the enclosure 2000 can be reduced.

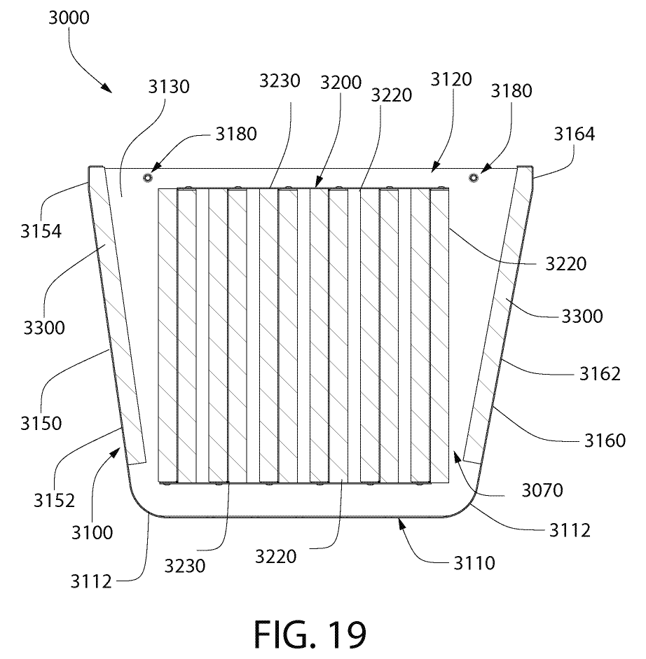

Further to the above, the sound attenuator 3000 comprises a housing 3100 and a panel assembly 3200 positioned in the housing 3100. The housing 3100 comprises an end panel 3110, a bottom panel 3130, and a top panel 3140. The housing 3100 further comprises a first side panel 3150 and a second side panel 3160 that are integrally formed with the end panel 3110. The end panel 3110, the first side panel 3150, and the second side panel 3160 are comprised of a contiguous sheet of metal that has been bent, or formed, into a substantially V-shaped configuration, for example. The end panel 3110 is flat, or at least substantially flat, and the first and second side panels 3150, 3160 extend away from the end panel 3110 at an angle. Referring primarily to FIG. 19, the first side panel 3150 comprises an angled portion 3152 connected to the end panel 3110 via a radiused corner 3112 and, in addition, a flat 3154 extending from the angled portion 3152 that is positioned adjacent a panel of the enclosure 2000 when the attenuator 3000 is attached to the enclosure 2000. Similarly, the second side panel 3160 comprises an angled portion 3162 connected to the end panel 3110 via a radiused corner 3112 and, in addition, a flat 3164 extending from the angled portion 3162 that is also positioned adjacent another panel of the enclosure 2000 when the attenuator 3000 is attached to the enclosure 2000. The angled portions 3152, 3162 of the side panels 3150, 3160 converge toward the end panel 3110 and the flats 3154, 3164 extend in directions that are parallel, or at least substantially parallel, to one another. The above being said, various other embodiments are envisioned in which the end panel 3110, the first side panel 3150, and/or the second side panel 3160 comprise separate components that are attached to each other via one or more fasteners and/or joining processes, such as welding, for example. Moreover, the end panel 3110, the first side panel 3150, and the second side panel 3160 can comprise any suitable configuration, such as a U-shaped configuration, for example.

Further to the above, the top panel 3140 comprises a flat, or an at least substantially flat, body 3142 and a plurality of side flanges 3144 extending downwardly therefrom. More specifically, the top panel 3140 comprises three side flanges, i.e., a side flange 3144 that extends alongside the end panel 3110, a side flange 3144 that extends alongside the first side panel 3150, and another side flange 3144 that extends alongside the second side panel 3160. The side flanges 3144 are used to connect the top panel 3140 to the end panel 3110, the first side panel 3150, and the second side panel 3160 via any suitable attachment mechanism. For instance, fasteners, such as screws, for example, extend through the side flanges 3144 into the end panel 3110, the first side panel 3150, and the second side panel 3160. In certain instances, the flanges 3144 can be welded, for example, to the end panel 3110, the first side panel 3150, and/or the second side panel 3160. In some instances, the flanges can be adhered to the end panel 3110, the first side panel 3150, and/or the second side panel 3160 using one or more adhesives, for example. Similarly, referring to FIG. 19, the bottom panel 3130 can be attached to the end panel 3110, the first side panel 3150, and/or the second side panel 3160 using any suitable attachment mechanism, such as those described herein, for example.

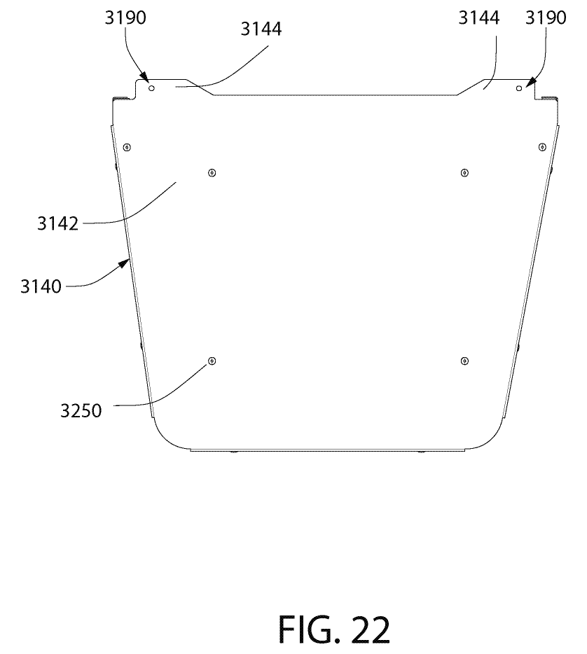

Further to the above, referring to FIGS. 19 and 22, the bottom panel 3130 and the top panel 3140 are triangular-shaped, for example; however, they can have any suitable shape. Moreover, the bottom panel 3130 and the top panel 3140 are parallel, or at least substantially parallel, to one another. Other embodiments are envisioned in which the bottom panel 3130 and the top panel 3140 converge toward one another at the end panel 3110.

Further to the above, the bottom panel 3130 has apertures 3180 defined therein that are configured to receive the mounting pegs 2680 extending upwardly from a side of the bottom panel 2600 of the enclosure 2000 when the attenuator 3000 is assembled to the enclosure 2000 in lieu of the first side panel 2400 or the second side panel 2500. Similar to the first and second side panels 2400, 2500, the housing 3100 of the attenuator 3000 is slid over the pegs 2680 until the top panel 3140 is aligned with the frame 2100 of the enclosure 2000. Similar to the first and second side panels 2400, 2500, the top panel 3140 has apertures defined therein, such as apertures 3190, for example, that are aligned with the apertures 2180 defined in the frame 2100 once the housing 3100 has been engaged with the pegs 2680. At such point, the top panel 3140 can be fastened to the frame 2100 by fasteners 2930, for example. As a result of this arrangement, the entirety of the first side panel 2400, or the second side panel 2500, is replaced by a sound attenuator 3000. Stated another way, an entire lateral side of the enclosure 2000 is replaced with an attenuator 3000. As a result of this arrangement, the attenuator 3000 can provide air flow surfaces and/or paths for the entire height and width of the enclosure 2000, as well as provide an additional depth for air flow surfaces and/or paths that the first and second side panels 2400, 2500 cannot provide.

Further to the above, the housing 3100 of the sound attenuator 3000 has a generally box-shaped configuration having an open end 3120 facing the interior 1100 of the enclosure 2000. Moreover, the housing 3100 has a second, or distal, end opposite the open end 3120 that is smaller than the open end 3120. The open end 3120, i.e., the end that engages the enclosure 2000, is defined by a perimeter that matches, or at least substantially matches, the perimeter of the first side panel 2400 and/or the second side panel 2500, for example. In various embodiments, the open end 3120 of the housing 3100 comprises an interface that is identical to the portions of the first side panel 2400 and/or the second side panel 2500 that interface with the enclosure 2000. As a result, a sound attenuator 3000 can comprise a complete substitute for the first side panel 2400 or the second side panel 2500 that interfaces with the enclosure 2000 in an identical manner to that of the first side panel 2400 and/or second side panel 2500.

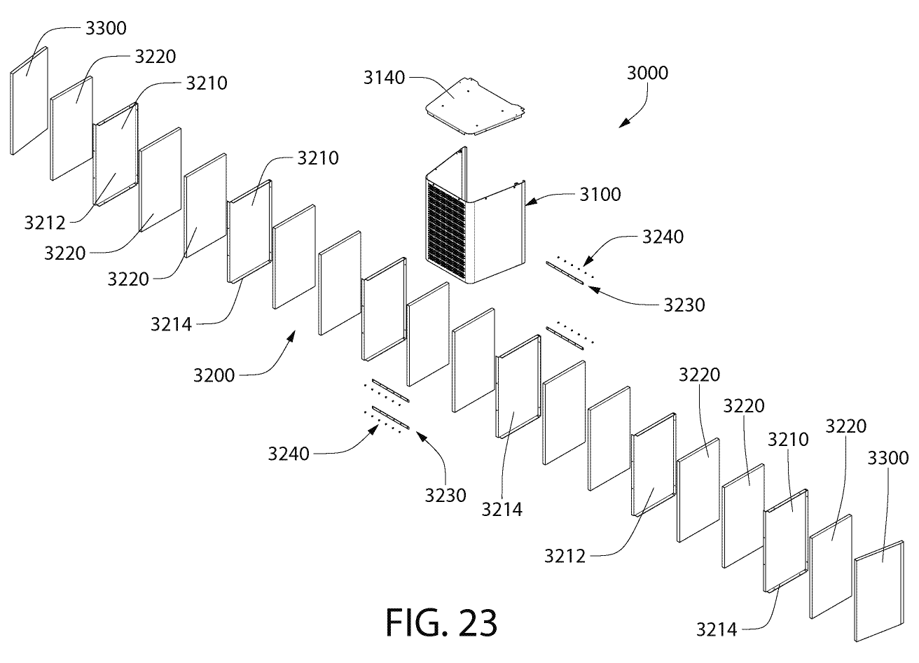

Further to the above, the panel assembly 3200 is positioned in the interior of the sound attenuator 3000. Referring primarily to FIGS. 19, 20, 20A, 21, and 23, the panel assembly 3200 comprises a plurality of supports 3210 and a plurality of sound absorbing panels, or baffles, 3220. Each support 3210 comprises a planar, or an at least substantially planar, body 3212 and flanges 3214 extending around the perimeter thereof. The flanges 3214 extend perpendicularly, or at least substantially perpendicularly, to the body 3212. Notably, for each support 3210, one or more of the flanges 3214 extend from the body 3212 in a first direction and one or more flanges 3214 extend from the body 3212 in a second, or opposite, direction. As a result of this arrangement, a support 3210 can support a first sound absorbing panel 3220 on a first side of the body 3212 and a second sound absorbing panel 3220 on a second, or opposite, side of the body 3212. Referring primarily to FIG. 23, the panel assembly 3200 has six supports 3210 and twelve sound absorbing panels 3220 – with each support 3210 supporting two panels 3220. That said, a panel assembly can have any suitable number of supports 3210 and panels 3220.

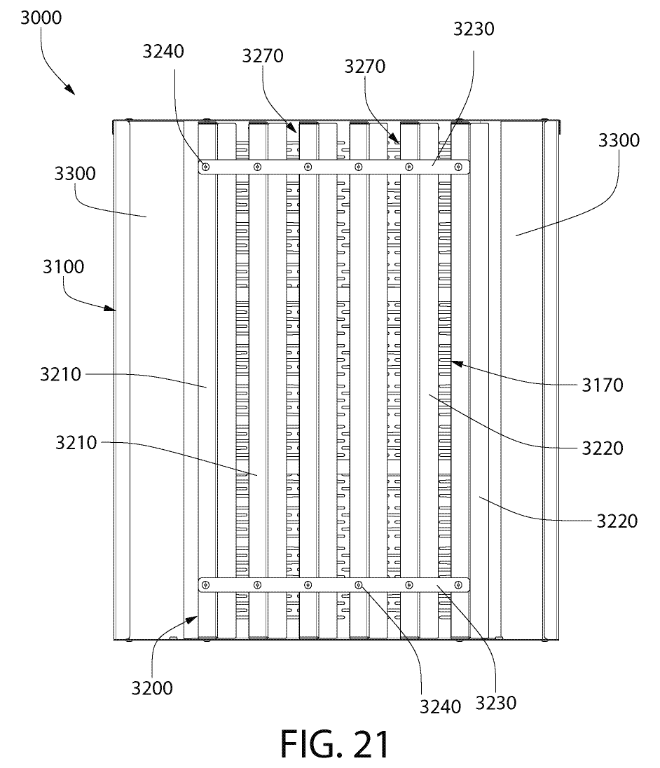

Further to the above, referring to FIGS. 21 and 23, the panel assembly 2300 further comprises brackets 3230 that hold the supports 3210 and the sound absorbing panels 3220 together. The panel assembly 2300 comprises four brackets 3230, for example, but can comprise any suitable number of brackets 3230. The brackets 3230 are fastened to the supports 3210 by fasteners, such as screws, 3240, for example, that extend through apertures defined in the brackets 3230 and threadably engage the flanges 3214 of the supports 3210. The fasteners 3240 are further configured to extend into and engage the sound absorbing panels 3220 supported by the supports 3210; however, other embodiments are envisioned in which the fasteners 3240 are configured such that they do not extend into the panels 3220. In certain embodiments, one or more adhesives can be used to secure the panels 3220 to the supports 3210. In various instances, the panel assembly 3200 is assembled and then inserted into the housing 3100 where it is then, referring to FIG. 16, fastened to the housing 3100 using one or more fasteners, such as screws, 3250, for example. In various instances, the panel assembly 3200 is fastened to the bottom panel 3130 and/or top panel 3140 of the housing 3100; however, the panel assembly 3200 can be attached to any suitable part of the housing 3100. Moreover, the panel assembly 3200 can be assembled to the housing 3100 in any suitable manner. Other instances are envisioned in which the panel assembly 3200 is at least partially assembled in situ within the housing 3100, for example.

Referring to FIG. 21, the brackets 3230 of the panel assembly 3200 hold the supports 3210 and the sound absorbing panels 3220 relative to one another such that gaps 3270 are present between at least some of the panels 3220. More specifically, each gap 3270 is flanked by a first panel 3220 on a first side and a second panel 3220 on a second, or opposite, side thereof. As a result of this arrangement, the sound energy of turbulent air flow, or exhaust flow, flowing through the sound attenuator 3000 can be efficiently absorbed. The same is true for laminar air flow and/or exhaust. Additionally, the panels 3200 are arranged such that they are parallel, or at least substantially parallel, to one another in a vertical orientation such that the gaps 3270 have a consistent width, or an at least substantially consistent width, along the length thereof. Moreover, the panels 3200 are arranged in a perpendicular, or at least substantially perpendicular, arrangement relative to the end panel 3110 of the housing 3100. By aligning the sound absorbing panels 3220 in this manner, air flowing through the sound attenuator 3000 can efficiently flow through apertures 3170 defined in the end panel 3110, through the gaps 3270 defined between the sound absorbing panels 3220, through the sound absorbing panels 3220, and/or around the sound absorbing panels 3220, and then into the interior 1100 of the enclosure 2000. In the alternative, exhaust exiting the enclosure 2000 through the sound attenuator 3000 can efficiently flow through the gaps 3270 defined between the sound panels 3220, through the sound panels 3220, and/or around the sound absorbing panels 3220 and then through the apertures 3170.

Further to the above, the sound absorbing panels 3220 are rectangular-shaped, for example; however, the panels 3220 can have any suitable shape. Moreover, the panels 3220 are arranged within the sound attenuator 3000 such that the long sides of the panels 3220 face the interior 1100 of the enclosure 2000 and, also, the end panel 3110 of the attenuator housing 3100. As a result of this arrangement, the edge exposure of the sound absorbing panels 3220 to incoming air and/or outgoing exhaust is increased as compared to when the short sides of the panels 3220 face the interior 1100 of the enclosure 2000 and the end panel 3100 of the attenuator housing 3100. The above being said, the panels 3200 can have any suitable arrangement.

Further to the above, the supports 3210, the brackets 3230, and/or the fasteners 3240 can be comprised of any suitable material, such as stainless steel, for example. In various embodiments, the supports 3210, the brackets 3230, and/or the fasteners 3240 can be comprised of one or more sound absorbing materials, such as one or more sound absorbing plastics, such as polyester, for example, which can, in various embodiments, have fiberglass embedded therein. In at least one embodiment, the supports 3210 are comprised of plastic having between 10% and 30% fiberglass, by weight, embedded therein, for example. The sound absorbing panels 3220 are comprised of one or more sound absorbing materials, such as fiberglass, mineral wool, open-cell foam, polyurethane foam, polyester felt, non-woven materials, and/or woven materials, for example. Regardless of the material chosen, it is envisioned that air, and/or exhaust, containing sound energy can pass over the panels 3220, and possibly through the panels 3220, such that at least some of the sound energy in the flowing air, and/or exhaust, is absorbed therefrom. Moreover, it is envisioned that sound energy that is emitted, or radiated, through the air, and/or exhaust, will be at least partially absorbed by the panels 3220, and possibly the supports 3210, for example.

Further to the above, referring particularly to FIG. 19, the sound attenuator 3000 further comprises sound absorbing panels, or baffles, 3300 mounted to the housing 3100. More specifically, a first panel 3300 is mounted to the first side wall 3150 and a second panel 3300 is mounted to the second side wall 3160. The panels 3300 can be mounted to their respective side walls 3150, 3160 by one or more fasteners and/or one or more adhesives, for example. In various instances, the panels 3300 can be comprised of one or more sound absorbing materials, such as fiberglass, mineral wool, open-cell foam, polyurethane foam, polyester felt, non-woven materials, and/or woven materials, for example. A passageway 3070 is defined between each panel 3300 and an adjacent sound absorbing panel 3220 that permits air, and/or exhaust, to flow through the sound attenuator 3000. Owing to the converging orientation of the first and second side panels 3150, 3160 of the housing 3100, further to the above, the passageways 3070 narrow from one end to the other. More specifically, each passageway 3070 comprises an inner end adjacent the interior 1100 of the enclosure 2000 and an opposite end adjacent the end panel 3110 of the housing 3100 which is narrower than the inner end. When a sound attenuator 3000 is used on the exhaust side of the enclosure 2000, exhaust flowing through the passageways 3070 toward the apertures 3170 defined in the end panel 3110 is pushed through an increasingly smaller volume and, as a result, the tapered configuration of the passageways 3070 can increase the contact between the exhaust and the sound absorbing panel 3300, as well as the adjacent sound absorbing panel 3220, to improve sound absorption.

Various embodiments are envisioned in which a sound attenuator 3000 includes both the panel assembly 3200 and the panels 3300, while other embodiments are envisioned in which a sound attenuator 3000 only includes the panel assembly 3200 or the panels 3300. In such embodiments, a sound attenuator 3000 having both the panel assembly 3200 and the panels 3300 will be able to absorb, or dissipate, sound energy at a higher rate than embodiments having only the panel assembly 3200 or the panels 3300. In various instances, a kit of sound attenuators 3000 can comprise a first sound attenuator 3000 configured to absorb sound at a first rate and a second sound attenuator 3000 configured to absorb sound at a second rate that is higher than the first rate. In at least one such instance, the first sound attenuator 3000 can be attached to the air inlet side of the enclosure 2000 and the second sound attenuator 3000 can be attached to the exhaust outlet side of the enclosure 2000 when it is envisioned that the exhaust outlet side of the generator 1000 will be louder than the air inlet side of the generator 1000. That said, the first and second sound attenuators 3000 can be attached to any suitable side of the generator 1000. As a result of the above, a less expensive sound attenuator 3000, i.e., a sound attenuator 3000 having less sound absorption material, can be used on one side of a generator when the sound level at that side is lower than the other side of the generator.

In various instances, further to the above, different kits of sound attenuators 3000 can be offered for sale to a consumer. For instance, a first kit can be offered comprising sound attenuators 3000 configured to absorb sound at a first rate and a second kit can be offered comprising sound attenuators 3000 configured to absorb sound at a second rate that is higher than the first rate. In such instances, the first kit can be provided when the generator 1000 is positioned remotely, such as in a field, for example, while the second kit can be provided when the generator 1000 is positioned adjacent to a house, for example, where additional sound dampening may be desired as compared to the first kit, for example. It is contemplated that more than two levels of sound attenuation may be offered for sale and/or otherwise provided via different sound attenuation kits.

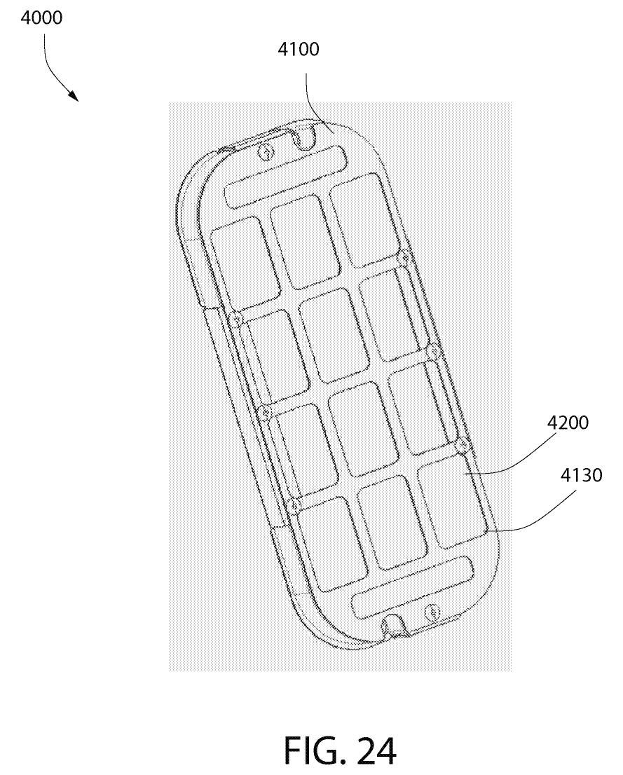

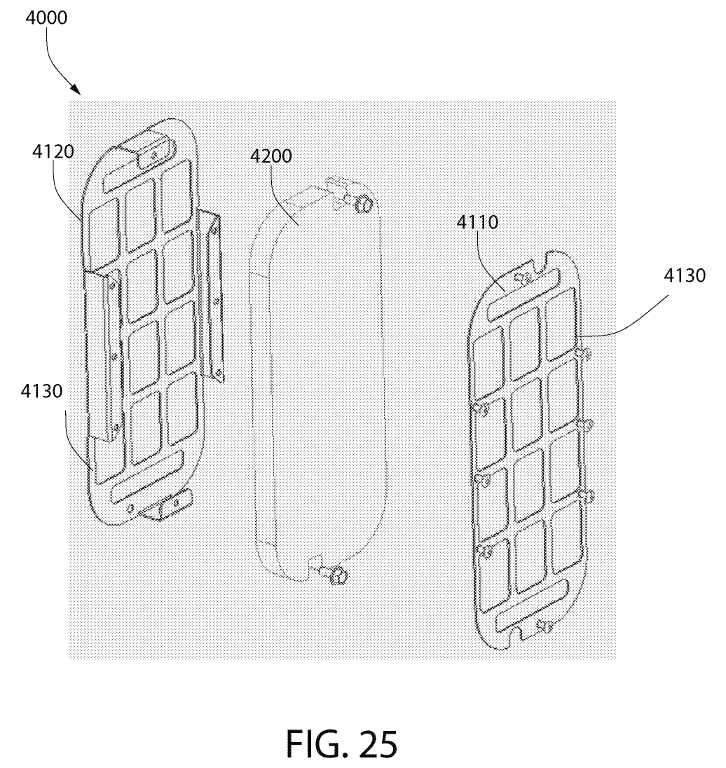

Further to the above, a kit of sound attenuators can include more than just the sound attenuators 3000. In at least one embodiment, a kit can include one or more sound attenuators 3000 and, in addition, a sound attenuator configured to attenuate sound energy that passes through the apertures 2370 in the rear panel 2300, for example. As described above, the apertures 2370 comprise an inlet for air to flow over the alternator 1300, for example, and positioning a sound attenuator in this flow path can reduce the sound emitted from the enclosure 2000. Referring to FIGS. 24 and 25, such a sound attenuator, i.e., sound attenuator 4000, for example, can comprise a housing 4100 and a sound absorbing panel 4200 positioned in the housing 4100. The housing 4100 comprises a first housing portion 4110 and a second housing portion 4120 attached to the first housing portion 4110 by one or more fasteners, clasps, and/or snap locks, for example. The housing 4100 can be comprised of any suitable material, such as plastic, for example. The sound absorbing panel 4200 can be comprised of any suitable material, such as the sound absorbing materials disclosed herein, for example. The first and second housing portions 4110 and 4120 both have openings 4130 defined therein that are configured to permit air to flow through the sound absorbing panel 4200. In at least one embodiment, the sound attenuator 4000 can be attached to the rear panel 2300 of the enclosure 2000, for example, and/or an air duct extending within the enclosure 2000, for example.

As described above, each sound attenuator 3000 comprises apertures 3170 defined therein that permit air to flow into the housing 3100 or permit exhaust gas to flow out of the enclosure 2000, depending on which side the sound attenuator 3000 is attached to the enclosure 2000. In various instances, the apertures 3170 can be sized, positioned, and/or arranged to attenuate one or more predetermined sound frequencies. In many instances, small holes attenuate different sound frequencies than larger holes. When a hole has a diameter that is smaller than the wavelength of a sound frequency, for example, the hole will act in a resistive manner for soundwaves having that frequency. This same principle can be applied to the apertures 2570 in the first side panel 2400 and the second side panel 2500, described above.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

What is claimed is:

1. A generator, comprising:
an engine;
an alternator driven by the engine; and
an enclosure, wherein the engine and the alternator are positioned in the enclosure, and wherein the enclosure comprises:
a frame;
a front panel attached to the frame;
a rear panel removably attached to the frame, wherein the rear panel is positioned opposite the front panel;
a first lateral side panel attached to the frame, wherein the first lateral side panel comprises an air inlet;
a second lateral side panel attached to the frame, wherein the second lateral side panel comprises an exhaust outlet, and wherein the second lateral side panel is positioned opposite the first lateral side panel;
a bottom panel attached to the frame, wherein the front panel, the rear panel, the first lateral side panel, the second lateral side panel, and the bottom panel define an enclosed space having an open top; and
a lid movably attached to the frame by a first hinge and a second hinge, wherein the lid is movable between an open position and a closed position, wherein the lid covers the open top when the lid is in its closed position, and wherein the entire lid is positioned vertically above the frame when the lid is in its open position such that the rear panel can be removed from the enclosure while the lid is in its open position.

2. The generator of claim 1, wherein the generator is mountable to a concrete pad at only two mounting locations in the bottom panel to withstand a 150 mph wind or less, wherein the generator is mountable to a concrete pad at four mounting locations in the bottom panel to withstand over a 150 mph wind, wherein two mounting locations are exposed when the front panel is detached from the frame, and wherein another two mounting locations are exposed when the rear panel is detached from the frame when the lid is in its open position.

3. The generator of claim 1, wherein the front panel, the first lateral side panel, and the second lateral side panel are each removably attached to the frame by one or more hook connectors, and wherein each hook connector comprises:
a base mount attached to the rear panel;
a hook arm extending downwardly from the base mount when the rear panel is attached to the frame; and
a slot comprising an open end and a closed end positioned opposite the open end, and wherein the slot is configured to receive a portion of the frame when the rear panel is attached to frame.

4. The generator of claim 1, wherein the lid is not positioned directly behind the rear panel when the panel is in its open position.

5. The generator of claim 1, wherein the first hinge comprises:
a first coupler that is rotatably mounted to the frame and to the lid; and
a second coupler that is rotatably mounted to the frame and to the lid.

6. The generator of claim 5, wherein the second coupler is closer to the rear panel than the first coupler, and wherein the second coupler is shorter than the first coupler.

7. The generator of claim 6, wherein the first coupler comprises a first leg, a second leg, and a bend between the first leg and the second leg.

8. The generator of claim 6, wherein the second coupler comprises a first leg, a second leg, and a bend between the first leg and the second leg.

9. The generator of claim 1, wherein the frame defines a top plane, and wherein the lid is oriented at an angle relative to the top plane when the lid is in its open position.

10. The generator of claim 9, wherein the angle is greater than 90 degrees.

11. An enclosure for a generator, the enclosure comprising:
a frame;
a front panel attached to the frame;
a rear panel removably attached to the frame, wherein the rear panel is positioned opposite the front panel;
a first lateral side panel attached to the frame, wherein the first lateral side panel comprises an air inlet;
a second lateral side panel attached to the frame, wherein the second lateral side panel comprises an exhaust outlet, wherein the second lateral side panel is positioned opposite the first lateral side panel, and wherein the front panel, the rear panel, the first lateral side panel, and the second lateral side panel define an interior space; and
a lid movably attached to the frame, wherein the lid is movable between an open position and a closed position, wherein the lid covers the interior space when the lid is in its closed position, and wherein the lid is not positioned directly behind the rear panel when the lid is in its open position such that the rear panel can be removed from the enclosure while the lid is in its open position.

12. The enclosure of claim 11, wherein the entire lid is positioned vertically above the rear panel and the frame when the lid is in its open position.

13. The enclosure of claim 11, wherein the frame defines a top plane, wherein the lid is oriented at an angle relative to the top plane when the lid is in its open position, and wherein the angle is greater than 90 degrees.

14. The enclosure of claim 11, wherein the frame defines a top plane, and wherein the entire lid is positioned vertically above the top plane when the lid is in its open position.

15. The enclosure of claim 11, wherein the lid is movably attached to the frame by two hinges, and wherein each hinge comprises:
a first coupler that is rotatably mounted to the frame and to the lid; and
a second coupler that is rotatably mounted to the frame and to the lid.

16. The enclosure of claim 15, wherein the second coupler is closer to the rear panel than the first coupler, and wherein the second coupler is shorter than the first coupler.

17. A generator, comprising:
an engine;
an alternator driven by the engine; and
an enclosure, wherein the engine and the alternator are positioned in an interior space defined in the enclosure, and wherein the enclosure comprises:
a frame, wherein a portion of the frame defines a top plane;
a front panel attached to the frame;
a rear panel removably attached to the frame, wherein the rear panel is positioned opposite the front panel;
a first lateral side panel attached to the frame, wherein the first lateral side panel comprises an air inlet;
a second lateral side panel attached to the frame, wherein the second lateral side panel comprises an exhaust outlet, and wherein the second lateral side panel is positioned opposite the first lateral side panel; and
a lid movably attached to the frame, wherein the lid is movable between an open position and a closed position, wherein the lid covers the interior space when the lid is in its closed position, and wherein the lid does not extend below the top plane when the lid is in its open position such that the rear panel can be removed from the enclosure while the lid is in its open position.

18. The generator of claim 17, wherein the lid is not positioned directly behind the rear panel when the lid is in its open position.

19. The generator of claim 17, wherein the rear panel extends vertically above the top plane.

20. The generator of claim 17, wherein the lid is oriented at an angle relative to the top plane when the lid is in its open position, and wherein the angle is greater than 90 degrees.
